(19) United States
(12) Patent Application Publication
(10) Pub. No.: US 2010/0247938 A1
(43) Pub. Date: Sep. 30, 2010

(54) MATERIAL FOR THREE-DIMENSIONAL MODELING, PROCESS FOR PRODUCING THREE-DIMENSIONAL MODEL, AND THREE-DIMENSIONAL MODEL

(75) Inventors: Junya ABE, Shizuoka (JP); Ryuki KAKINO, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/685,224

(22) Filed: Jan. 11, 2010

(30) Foreign Application Priority Data
Mar. 25, 2009 (JP) 2009-075002

(51) Int. Cl. B32B 27/30; B32B 37/24

(52) U.S. Cl. 428/500; 156/62.2

(57) ABSTRACT

A process for producing a three-dimensional model is provided that includes sequentially repeating a layer formation step of forming on a support a layer of (A) a powder material, the layer having a predetermined thickness, and a bonding step of bonding the powder material in the layer with (B) a binder so as to give a cross-sectional shape of a modeled object that has been sectioned into parallel cross-sections, the binder containing a polymer having a heteroaromatic ring group-containing monomer unit. There is also provided a three-dimensional model produced by the process for producing a three-dimensional model.

### BACKGROUND OF THE INVENTION

1. Field of the Invention

The present invention relates to a material for three-dimensional modeling, a process for producing a three-dimensional model, and a three-dimensional model.

2. Description of the Related Art

There is a conventionally known technique to produce a model, which is a three-dimensional model of a modeled object, by bonding with a binder a thin layer of powder material corresponding to each cross-sectional shape of a solid modeled object that has been sectioned into a plurality of parallel plane cross-sectional shapes, and sequentially layering these bonded thin cross-sectional shaped layers.

Such a technique is known as rapid prototyping, and can be utilized in applications such as component prototyping and design verification. Recently, a system employing an inkjet method, which is inexpensive, fast, and suitable for the production of a color model, has been proposed and is disclosed in, for example, published Japanese translation 2003-531220 of a PCT application and JP-A-2005-35299 (JP-A denotes a Japanese unexamined patent application publication). A specific procedure for this solid modeling is explained below.

The procedure for solid modeling described in published Japanese translation 2003-531220 of a PCT application is now explained. Firstly, a thin layer of a powder material is spread on a flat surface by means of a blade mechanism so as to have a uniform thickness, and an inkjet nozzle head is made to scan and discharge a binder onto the surface of the thin powder material layer according to a cross-sectional shape of a modeled object that has been sectioned into parallel cross-sections. The powder material in the region where the binder has been discharged is subjected to an operation necessary to put it into a bonded state and also to bond it to the cross-sectional shape of a lower layer that has already been formed. These steps of sequentially forming a thin powder material layer on top and discharging the binder are repeated until the whole model is completed. Finally, the powder material in a region to which no binder has been applied can be removed easily when the model is taken out from the equipment and the target model can be separated because the powder material particles are individually independent and not bonded to each other. In accordance with the above-mentioned operations, a desired three-dimensional model can be produced.

JP-A-2005-35299 discloses a method for freeforming a solid three-dimensional article in which a) a first inkjet-dischargeable composition comprising a reactive constituent material and a second inkjet-dischargeable composition comprising a curing agent are individually discharged by inkjet onto a substrate thus contacting the reactive constituent material and the curing agent to thereby cause a reaction and form a solidified composition without requiring UV curing, and b) the inkjet discharge step is repeated so that a plurality of layers of the solidified composition are built up, thus continuously bonding the plurality of layers to each other so as to form a solid three-dimensional article.

### BRIEF SUMMARY OF THE INVENTION

An object of the present invention is to provide a material for three-dimensional modeling that has good inkjet discharge suitability and good liquid penetration into a powder material and gives a three-dimensional model having high strength, a process for producing a three-dimensional model, and a three-dimensional model produced by the production process.

The object can be attained by means described in <1>, <8> or <10> below. They are described below together with <2> to <7> and <9>, which are preferred embodiments.

<1> A material for three-dimensional modeling comprising (A) a powder material and (B) a binder for bonding the powder material (A), the binder comprising a polymer having a heteroaromatic ring group-containing monomer unit,
<2> the material for three-dimensional modeling according to <1>, wherein the heteroaromatic ring group-containing monomer unit is represented by Formula (1) below,

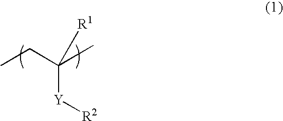

(in Formula (1), R¹ denotes a hydrogen atom or a hydrocarbon group having 1 to 6 carbon atoms, Y denotes a single bond or a divalent linking group selected from the group consisting of an alkylene group having 1 to 6 carbon atoms, an ester bond, an amide bond, an ether bond, a urethane bond, a urea bond, a thioether bond, and a combination thereof, and R² denotes a 5-membered or 6-membered heteroaromatic ring group having at least one heteroatom selected from the group consisting of a nitrogen atom, an oxygen atom, and a sulfur atom)
<3> the material for three-dimensional modeling according to <2>, wherein in Formula (1) Y denotes a single bond,
<4> the material for three-dimensional modeling according to <2> or <3>, wherein in Formula (1) R² denotes a heteroaromatic ring group having a nitrogen atom as a heteroatom,
<5> the material for three-dimensional modeling according to <2> or <3>, wherein in Formula (1) R² is selected from the group consisting of a pyridyl group, a thienyl group, and a furyl group,
<6> the material for three-dimensional modeling according to any one of <2> to <5>, wherein in Formula (1) R² is a pyridyl group,
<7> the material for three-dimensional modeling according to any one of <1> to <6>, wherein the polymer having a heteroaromatic ring group-containing monomer unit has a weight-average molecular weight of at least 3,000 but no greater than 100,000,
<8> a process for producing a three-dimensional model, the process comprising sequentially repeating a layer formation step of forming on a support a layer of a powder material, the layer having a predetermined thickness, and a bonding step of bonding the powder material in the layer with a binder so as to give a cross-sectional shape of a modeled object that has been sectioned into parallel cross-sections, the material for three-dimensional modeling according to any one of <1> to <7> being used as the powder material and the binder,
<9> the process for producing a three-dimensional model according to <8>, wherein in the bonding step the binder is discharged by inkjet, and
<10> a three-dimensional model produced by the process for producing a three-dimensional model according to <8> or <9>.

### BRIEF DESCRIPTION OF DRAWING

FIG. 1 A schematic view showing main steps of one embodiment of the process for producing a three-dimensional model of the present invention.

FIG. 2 A perspective view schematically showing cross-sectional shapes formed in adjacent layers in the production of a three-dimensional model.

FIG. 3 A plan view showing one example of cross-sectional data finely divided into a grid and formed in the second step.

### EXPLANATION OF REFERENCE NUMERALS AND SYMBOLS

1: thin layer
2: region to which binder applied
3: three-dimensional modeling section
4: support (modeling stage)
5: vertically moving section
6: frame
7: blade
8: inkjet head
10: three-dimensional model

### DETAILED DESCRIPTION OF THE INVENTION

### I. Material for Three-Dimensional Modeling

The material for three-dimensional modeling (hereinafter, also called a ‘material set’) of the present invention comprises (A) a powder material and (B) a binder for bonding the powder material (A), the binder comprising a polymer having a heteroaromatic ring group-containing monomer unit.

In published Japanese translation 2003-531220 of a PCT application, an inorganic compound is used as a particulate material, and a hydration-bonding force occurring between the particulate material and water, which is a solvent for a modeling material, is used as a main curing action, but these particulate materials make non-colored particles attach to the surface of a finished model during the process of penetration, thus giving rise to the problem that the color of the model is degraded. When an organic compound is used as a particulate material, if a polymer material as a bonding adjuvant shown in published Japanese translation 2003-531220 of a PCT application is used on its own, strength for forming a three-dimensional model is not exhibited, and if the content of the bonding adjuvant in the modeling material is increased, the discharge suitability is degraded since the viscosity increases, and there is thus the problem that it is impossible to satisfy the two requirements, that is, a model with high strength and improved color. Furthermore, there are the problems that liquid penetration into the particles is degraded due to increase in viscosity, the liquid does not penetrate so as to follow discharge by inkjet, the modeling precision is degraded, and the shape of a model is impaired.

In JP-A-2005-35299, curing of an organic compound is made possible by using a two liquid system, but there are the problems that the use of a plurality of inkjet nozzles makes the system complicated, and the use of a reactive organic compound causes degradation in stability over time.

In the present invention, as a result of an intensive investigation, a three-dimensional model with high strength can be obtained by using as a binder a polymer having a heteroaromatic ring group-containing monomer unit, thus suppressing any increase in viscosity due to physical bonding forces characteristic of a water-soluble polymer and preventing drying of nozzles due to an aqueous solvent being contained, while maintaining discharge stability and liquid penetration.

Each component is explained in detail below. In the explanation below, the statement ‘A to B’ denoting a range of numerical values means ‘at least A but no greater than B’ unless otherwise specified. That is, it means a range of numerical values that includes the end points A and B.

### (A) Powder Material

The material for three-dimensional modeling of the present invention is a material set comprising mainly a combination of (A) a powder material and (B) a binder.

The powder material used in the present invention is preferably a fine powder having an average particle size of no greater than 100 μm, and more preferably a fine powder having an average particle size of 0.8 to 50 μm. It is preferable for the average particle size to be in the above-mentioned range since a three-dimensional model obtained has improved surface gloss.

The powder used may have any shape, such as amorphous, spherical, tabular, acicular, or porous.

The powder material used may be any of an organic powder, an inorganic powder, and an inorganic/organic composite powder, but it is preferable to use an organic powder.

Examples of the organic powder include synthetic resin particles and natural polymer particles. It is preferable to use synthetic resin particles. Specific examples thereof include acrylic resins, olefin resins, phenolic resins, styrene resins, divinylbenzene resins, urethane resins, polyester, polyamide, polyimide, acrylonitrile-butadiene-styrene copolymers, polyacrylonitrile, epoxy resins, fluorine resins, melamine formaldehyde resins, polycarbonate, sulfone polymers, vinyl polymers, carboxymethylcellulose, gelatin, starch, chitin, and chitosan. Among these, acrylic resins, olefin resins, phenolic resins, styrene resins, divinylbenzene resins, fluorine resins, and/or urethane resins can be used preferably, and acrylic resins, olefin resins, phenolic resins, styrene resins, divinylbenzene resins, and/or fluorine resins can be used more preferably. With regard to the resins, they may be used on their own or two or more types thereof may be used in combination.

The acrylic resin referred to here means a resin obtained by homopolymerization or copolymerization of a (meth)acrylic monomer such as (meth)acrylic acid, a (meth)acrylate ester, a (meth)acrylamide, or a (meth)acrylonitrile. The above-mentioned notation ‘(meth)acrylic acid’ is an abbreviation denoting that it can take either the methacrylic acid structure or the acrylic acid structure.

Examples of the (meth)acrylate ester include methyl (meth)acrylate, ethyl (meth)acrylate, butyl (meth)acrylate, lauryl (meth)acrylate, stearyl (meth)acrylate, 2-hydroxyethyl (meth)acrylate, 2-hydroxypropyl (meth)acrylate, 2-dimethylaminoethyl (meth)acrylate, and glycidyl (meth)acrylate. As the acrylic resin, poly(methyl methacrylate) can be used preferably. Examples of other acrylic resins include resins described in ‘Kobunshi Daijiten’ (Polymer Dictionary), Translated under the supervision of T. Mita, Maruzen Co., Ltd. (1994), pp. 6-12.

The olefin resin denotes a polymer of an olefin, and examples thereof include polyethylene, polypropylene, polyisobutylene, poly(1-butene), poly(1-pentene), poly(3-methyl-1-butene), poly(1-hexene), poly(3-methyl-1-pentene), poly(4-methyl-1-pentene), poly(1-heptene), poly(4-methyl-1-hexene), and poly(5-methyl-1-hexene). Polyethylene and polypropylene can be used preferably. Examples of other olefin resins include resins described in ‘Kobunshi Daijiten’ (Polymer Dictionary), Translated under the supervision of T. Mita, Maruzen Co., Ltd. (1994), pp. 102-109.

The phenolic resin denotes a resin obtained by addition-condensation of a phenol and an aldehyde. When an acid catalyst is used in an addition-condensation reaction, a novolac type resin is obtained, and when a base catalyst is used, a resol type resin is obtained. Examples of the phenol include phenol, p-cresol, m-cresol, and resorcinol. Examples of the aldehyde include formaldehyde, salicylaldehyde, and s-trioxane. Examples of other phenols and aldehydes include compounds described in ‘Jikken Kagaku Koza’ (Experimental Chemistry Series) 28 Polymer Synthesis 4th Edition (1992), pp. 427-430, Edited by The Chemical Society of Japan.

The styrene resin denotes a homopolymer or a copolymer of a styrene monomer. Examples of the styrene monomer include styrene, o-methylstyrene, m-methylstyrene, p-methylstyrene, α-methylstyrene, o-chlorostyrene, p-chlorostyrene, and chloromethylstyrene. Polystyrene can be used preferably. Examples of the copolymer of a styrene monomer include copolymers described in ‘Kobunshi Daijiten’ (Polymer Dictionary), Translated under the supervision of T. Mita, Maruzen Co., Ltd. (1994), pp. 506-507.

The divinylbenzene resin denotes a homopolymer or a copolymer of a divinylbenzene monomer. Examples of the divinylbenzene monomer include divinylbenzene and chlorodivinylbenzene. Examples of a monomer that is copolymerized with the divinylbenzene monomer include the above-mentioned styrene monomers. As the divinylbenzene resin, polydivinylbenzene can be used preferably.

The fluorine resin is a fluorine-containing polymer. Examples of the fluorine resin include polyvinyl fluoride, polyvinylidene fluoride, polytetrafluoroethylene, a tetrafluoroethylene-hexafluoropropylene copolymer, and a tetrafluoroethylene-perfluorovinyl ether copolymer. In particular, polytetrafluoroethylene can be used preferably.

The urethane resin denotes a polymer obtained by addition-polymerization of a polyfunctional isocyanate and a polyol. Examples of the polyfunctional isocyanate include toluene diisocyanate, diphenylmethane diisocyanate, naphthalene 1,5-diisocyanate, tolylene diisocyanate, hexamethylene diisocyanate, and isophorone diisocyanate. Examples of the polyol include a polyether polyol, a polyester polyol, and an aliphatic polyol.

Examples of other polyfunctional isocyanates and polyols include compounds described in, for example, ‘Poriuretan Handobukku’ (Polyurethane Handbook), Ed. by K. Iwata, The Nikkan Kogyo Shimbun Ltd. (1987) pp. 77-81 and pp. 99-117.

Examples of the inorganic powder include metals, oxides, composite oxides, hydroxides, carbonates, sulfates, silicates, phosphates, nitrides, carbides, sulfides, and composites of at least two types thereof. Specific examples thereof include magnesium hydroxide, silica gel, alumina, aluminum hydroxide, glass, titanium oxide, zinc oxide, zirconium oxide, tin oxide, potassium titanate, aluminum borate, magnesium oxide, magnesium borate, calcium hydroxide, basic magnesium sulfate, calcium carbonate, magnesium carbonate, calcium sulfate, magnesium sulfate, calcium silicate, magnesium silicate, calcium phosphate, silicon nitride, titanium nitride, aluminum nitride, silicon carbide, titanium carbide, zinc sulfide, and composites of at least two types thereof. Preferred examples include magnesium hydroxide, silica gel, alumina, aluminum hydroxide, glass, calcium carbonate, magnesium carbonate, calcium sulfate, and magnesium sulfate.

In the present invention, among these powder materials it is preferable to use an acrylic resin or a urethane resin, and it is more preferable to use an acrylic resin. The above-mentioned powder materials are preferable since penetration of a binder is good.

### (B) Binder

The material for three-dimensional modeling of the present invention comprises (B) a binder for bonding the powder material.

Furthermore, the binder comprises a polymer having a heteroaromatic ring group-containing monomer unit (hereinafter, a ‘polymer having a heteroaromatic ring group-containing monomer unit’ is also called a ‘heteroaromatic ring group-containing polymer’ or a ‘specific polymer’).

The binder preferably comprises a colorant in addition to the specific polymer, and may comprise a polymer other than the specific polymer. It may further comprise another component.

Furthermore, the binder may comprise a powder material such as a known filler, but the content of the powder material, relative to the total weight of the binder, is preferably no greater than 5 wt %, and more preferably no greater than 1 wt %, and it is particularly preferable for the binder not to contain a powder material.

Each of the components forming the binder is explained in detail below. Specific polymer (polymer having heteroaromatic ring group-containing monomer unit)

In the present invention, the binder constituting the material for three-dimensional modeling comprises a polymer having a heteroaromatic ring group-containing monomer unit (also called a ‘heteroaromatic ring group-containing polymer’, or a ‘specific polymer’).

The heteroaromatic ring group-containing polymer used in the present invention is suitably a homopolymer formed from a monomer unit represented by Formula (1) below or a copolymer having a monomer unit represented by Formula (1) and another monomer unit. The other monomer unit is preferably one derived from an ethylenically unsaturated compound (ethylenically unsaturated monomer).

That is, the specific polymer is preferably a homopolymer of a monomer represented by Formula (1′) below or a copolymer of a monomer represented by Formula (1′) and another monomer. In the explanation below, for convenience it is mainly the monomer represented by Formula (1′) that is explained, but from the description below a person skilled in the art can also naturally understand a monomer unit (monomer unit represented by Formula (1)) derived from a monomer represented by Formula (1′).

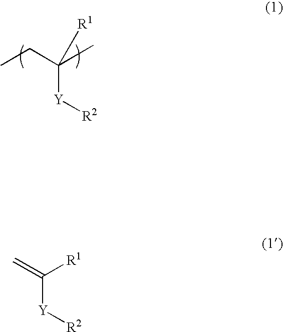

In Formula (1) and Formula (1′), R¹ denotes a hydrogen atom or a hydrocarbon group having 1 to 6 carbon atoms, Y denotes a single bond or a divalent linking group, and R² denotes a heteroaromatic ring group having at least one heteroatom selected from the group consisting of a nitrogen atom, an oxygen atom, and a sulfur atom.

In Formula (1) and Formula (1′) above, R¹ denotes a hydrogen atom or a hydrocarbon group having 1 to 6 carbon atoms, R¹ is preferably a hydrogen atom or an alkyl group having 1 to 3 carbon atoms, and R¹ is more preferably a hydrogen atom or a methyl group.

Y denotes a single bond or a divalent linking group, and the divalent linking group is preferably a divalent linking group selected from the group consisting of an alkylene group having 1 to 6 carbon atoms, an imino bond (—NH—), an ether bond (—O—), a carbonyl group (—C(═O)—), a thioether bond (—S—), and a combination thereof. Examples of the divalent linking group in which they are combined include an ester bond (—C(═O)—O—), an amide bond (—NH—C(═O)—), a urethane bond (—NH—C(═O)—O—), a urea bond (—NH—C(═O)—NH—), an alkyleneoxy group (e.g. an ethyleneoxy group (—CH₂CH₂O—), a propyleneoxy group (—CH(CH₃)CH₂O—, —CH₂CH(CH₃)O—, —CH₂CH₂CH₂O—), etc.), and an alkylenethio group (e.g. an ethylenethio group (—CH₂CH₂S—)).

Among them, Y is preferably a single bond or a divalent linking group selected from the group consisting of an alkylene group having 1 to 6 carbon atoms, an ester bond, an amide bond, an ether bond, a urethane bond, a urea bond, a thioether bond, and a combination thereof, more preferably a single bond or a divalent linking group selected from the group consisting of an alkylene group having 1 to 3 carbon atoms, an ester bond, an amide bond, an alkyleneoxy group, an alkylenethio group, and a combination thereof, yet more preferably a single bond, an ester bond, an amide bond, a urethane bond, a urea bond, —C(═O)—O—CH₂CH₂O—, or —C(═O)—O—CH₂CH₂S—, and particularly preferably a single bond.

Y above may have a substituent; examples of the substituent include an alkyl group having 1 to 6 carbon atoms (methyl group, ethyl group, propyl group, butyl group, etc,), a halogen atom (fluorine atom, chlorine atom, bromine atom, iodine atom), a cyano group, a nitro group, a hydroxy group, an alkoxy group having 1 to 6 carbon atoms, a sulfonyl group, a carboxyl group, a thienyl group, and an azide group, and these substituents may further be substituted.

R² denotes a heteroaromatic ring group having at least one heteroatom selected from the group consisting of a nitrogen atom, an oxygen atom, and a sulfur atom.

R² may have at least one heteroatom (X) selected from the group consisting of a nitrogen atom, an oxygen atom, and a sulfur atom and may have two or more heteroatoms. It may have only one type of heteroatom or may have a plurality of types of heteroatoms as in a heteroaromatic ring group having a nitrogen atom and an oxygen atom or a heteroaromatic group having a nitrogen atom and a sulfur atom.

The heteroaromatic ring in the heteroaromatic ring group is particularly preferably a 5-membered or 6-membered ring.

In addition, R² may form a condensed polycycle. Specifically, a 5-membered ring pyrrolyl group may further form a condensed polycycle, thus forming an indolyl group or an isoindolyl group. When R² is an indolyl group, in the present invention R² is a 5-membered ring heteroaromatic ring group.

The heteroatom (X) is selected from the group consisting of a nitrogen atom, a sulfur atom, and an oxygen atom, preferably comprises a nitrogen atom or an oxygen atom, and more preferably comprises a nitrogen atom. When there are a plurality of heteroatoms, a combination of a nitrogen atom and a sulfur atom and a combination of a nitrogen atom and an oxygen atom are preferable, and a combination of a nitrogen atom and an oxygen atom is more preferable.

Among them, it is most preferable that there is only a nitrogen atom as the heteroatom.

The number of heteroatoms (X) in R² is preferably 1 to 4, more preferably 1 to 2, and yet more preferably 1.

R² may have a substituent on the heteroaromatic ring.

Examples of the substituent that the heteroaromatic ring of R² may have include an alkyl group having 1 to 6 carbon atoms (methyl group, ethyl group, propyl group, butyl group, etc.), a halogen atom (fluorine atom, chlorine atom, bromine atom, iodine atom), a cyano group, a nitro group, a hydroxy group, an alkoxy group having 1 to 6 carbon atoms, a sulfonyl group, a carboxyl group, a thienyl group, and an azide group, and these substituents may further be substituted.

Specific examples of R² include groups formed by removing one hydrogen atom from pyrrole, furan, thiophene, imidazole, indole, benzofuran, benzothiophene, isoindole, pyrazole, benzoimidazole, purine, oxazole, thiazole, pyridine, quinoline, pyrazine, quinoxaline, acridine, pyrimidine, pyridazine, and cinnoline.

Among them, R² is preferably a pyridyl group, a thienyl group, or a furyl group, and more preferably a pyridyl group.

Furthermore, R² is preferably a group selected from the group consisting of a 3-furyl group, a 3-pyrrolyl group, a 3-thienyl group, a 5-imidazolyl group, a 4-oxazolyl group, a 4-thiazolyl group, a 2-indolyl group, a 3-indolyl group, a 1-isoindolyl group, a 3-benzofuranyl group, a 3-benzothionyl group, a 2-benzoimidazolyl group, an 8-(9H-purinyl) group, a 3-pyridyl group, a 4-pyridyl group, a 2-pyrazinyl group, a 6-pyrimidinyl group, a 4-pyridazinyl group, a 3-quinolyl group, a 4-quinolyl group, a 3-cinnolinyl group, a 4-cinnolinyl group, a 9-acridinyl group, and a 2-quinoxalinyl group, and more preferably a 3-furyl group, a 3-thienyl group, or a 4-pyridyl group.

More preferred specific examples of the monomer represented by Formula (1′) are shown below, but the present invention is not limited to the specific examples below. In some of the chemical structures in the present invention, a hydrocarbon chain is given as a simplified structural formula in which symbols for carbon (C) and hydrogen (H) are omitted.

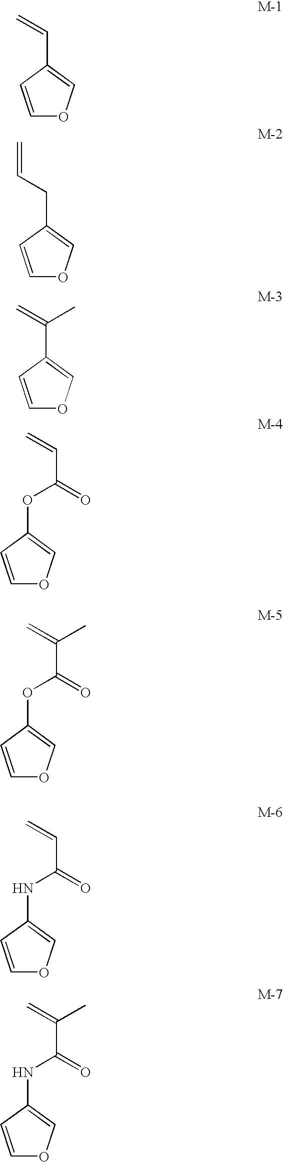

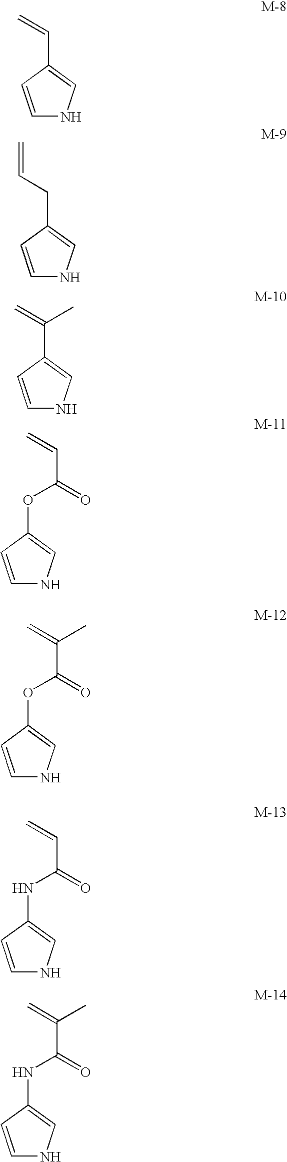

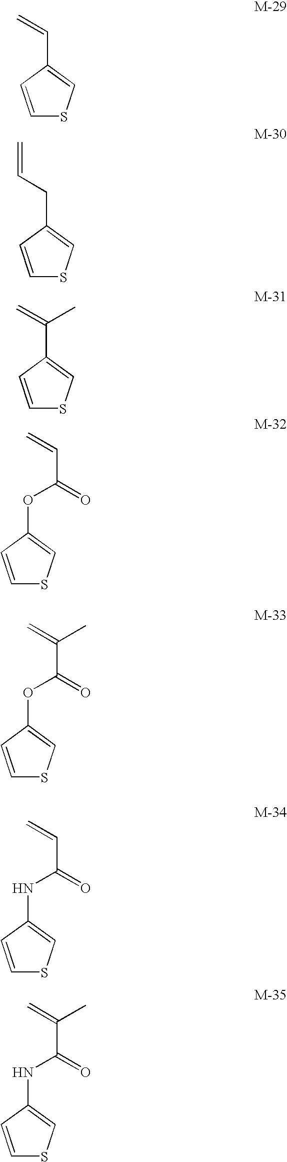

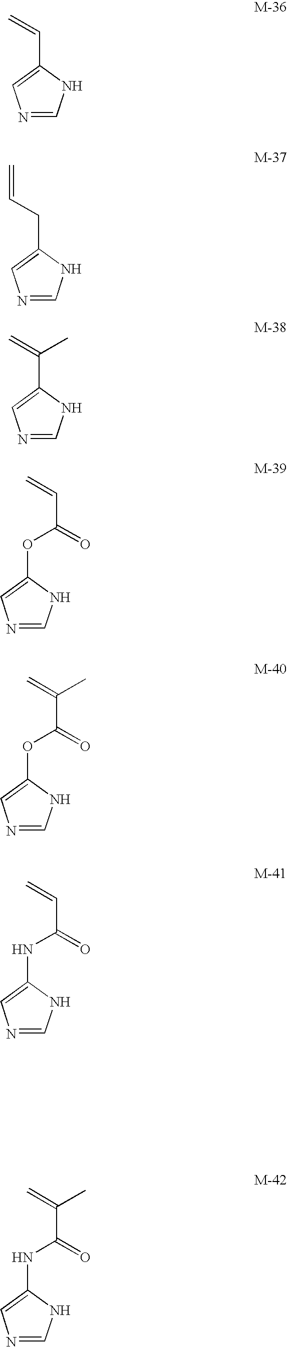

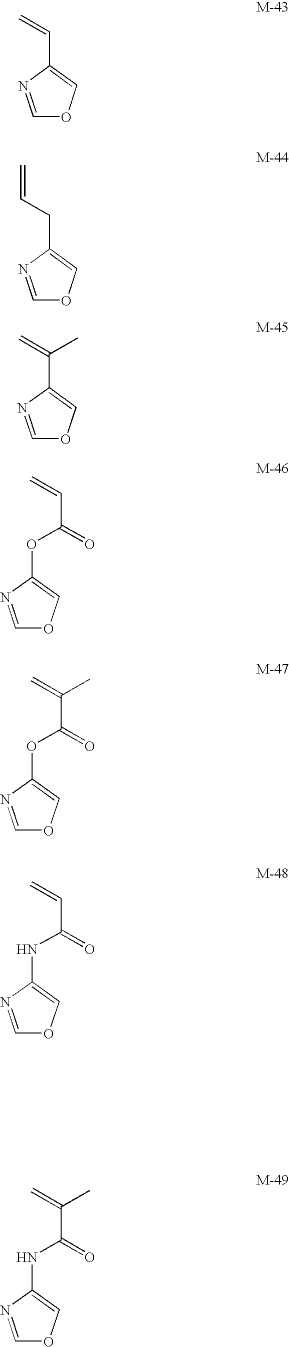

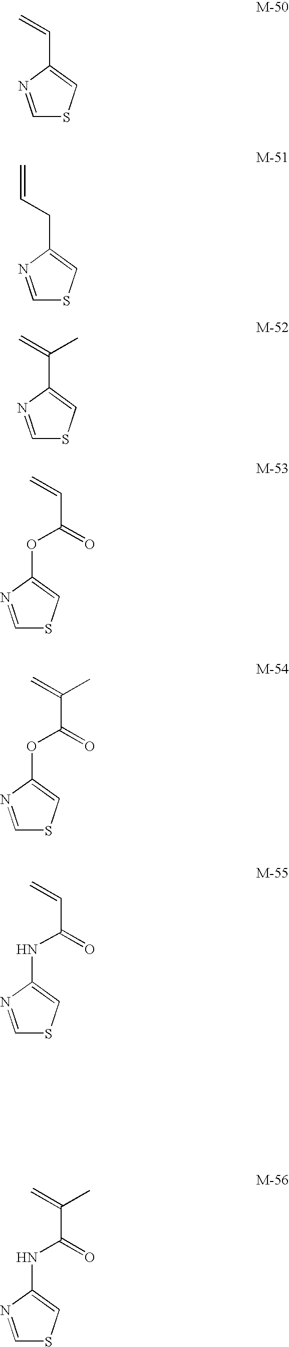

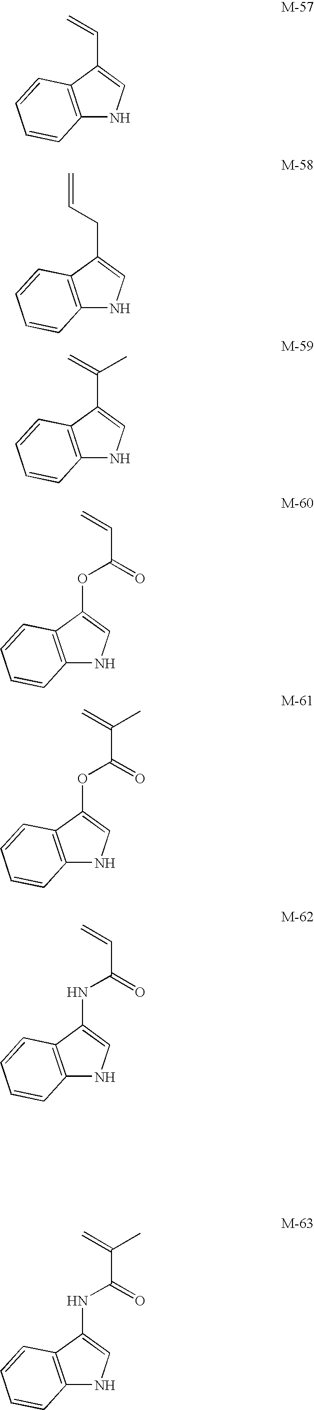

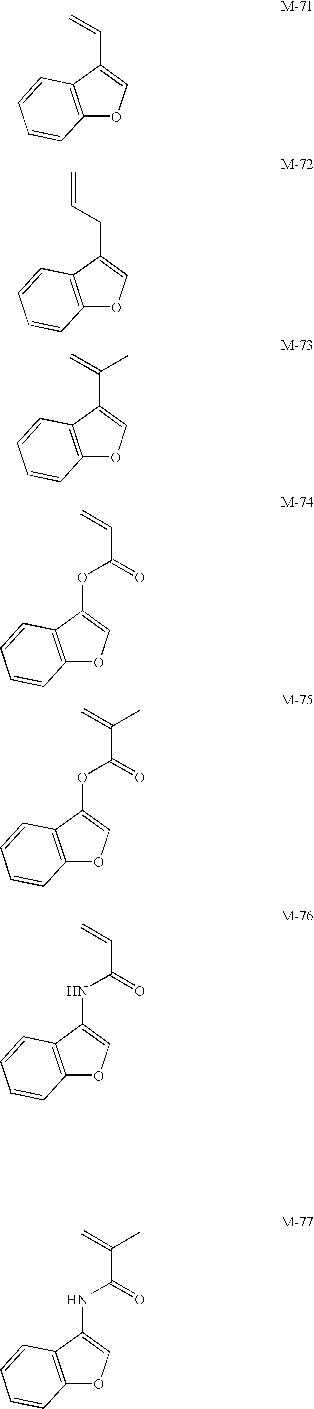

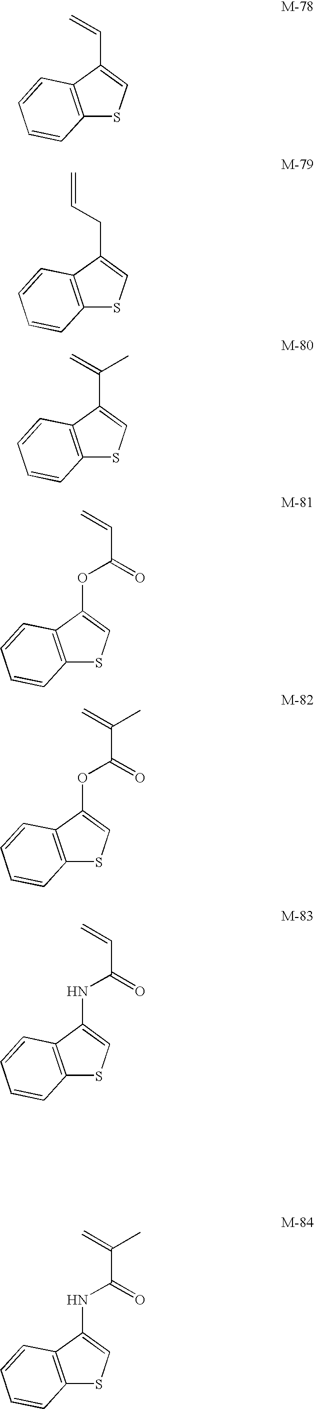

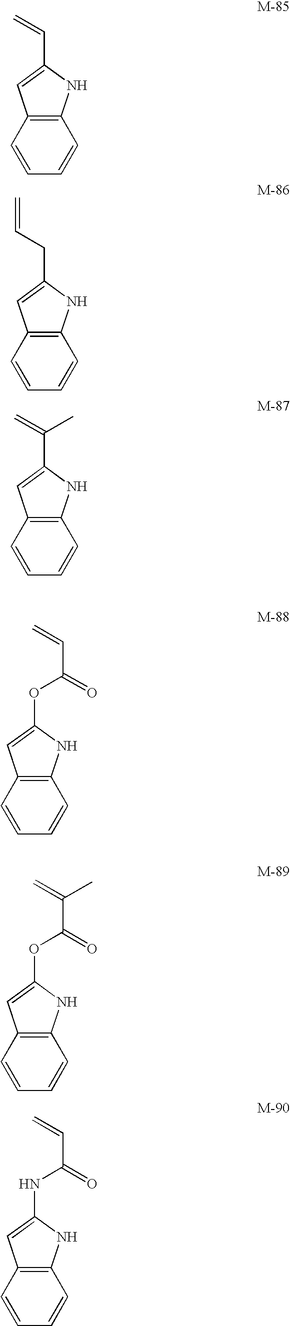

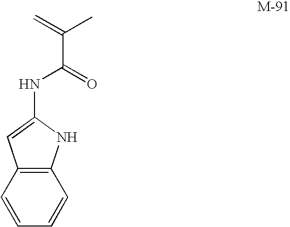

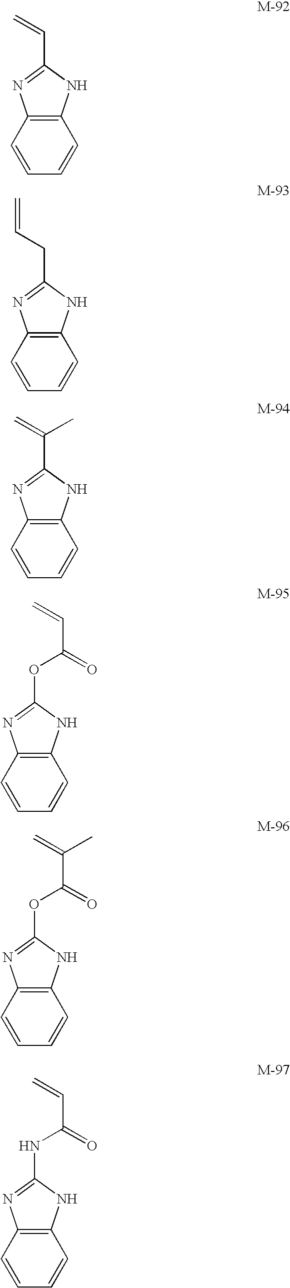

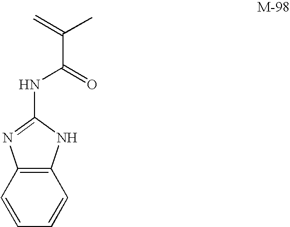

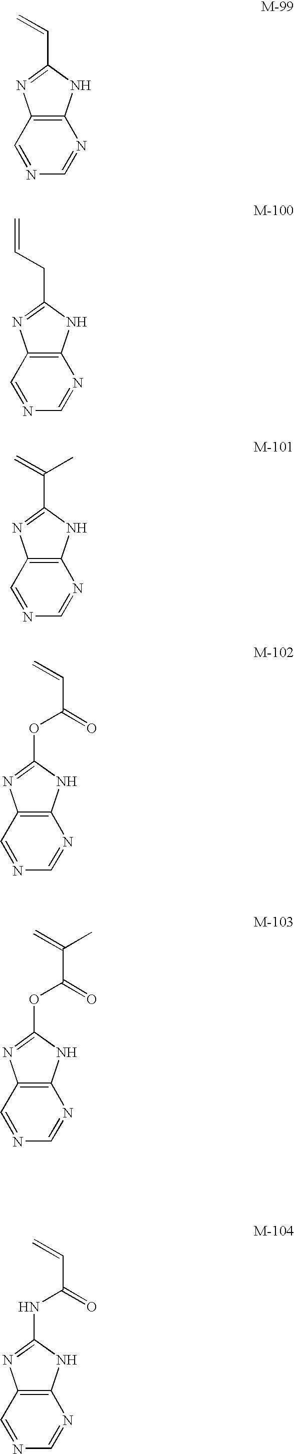

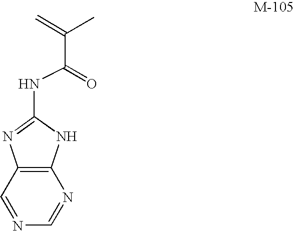

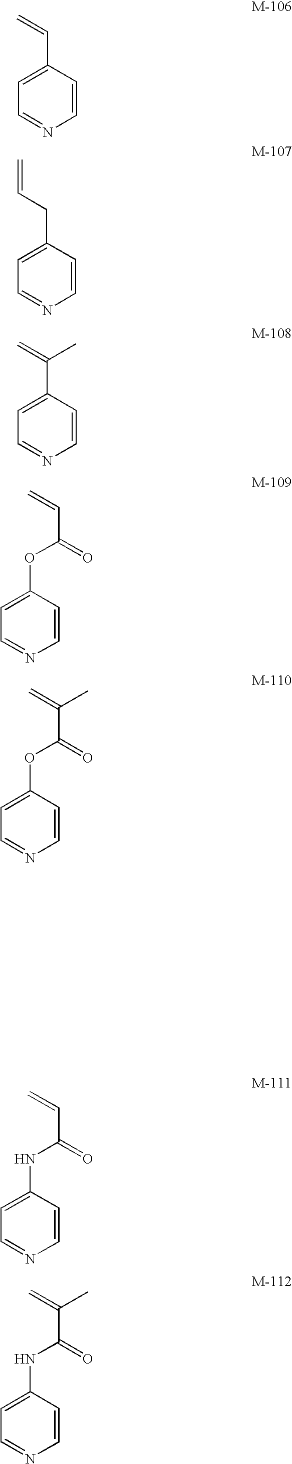

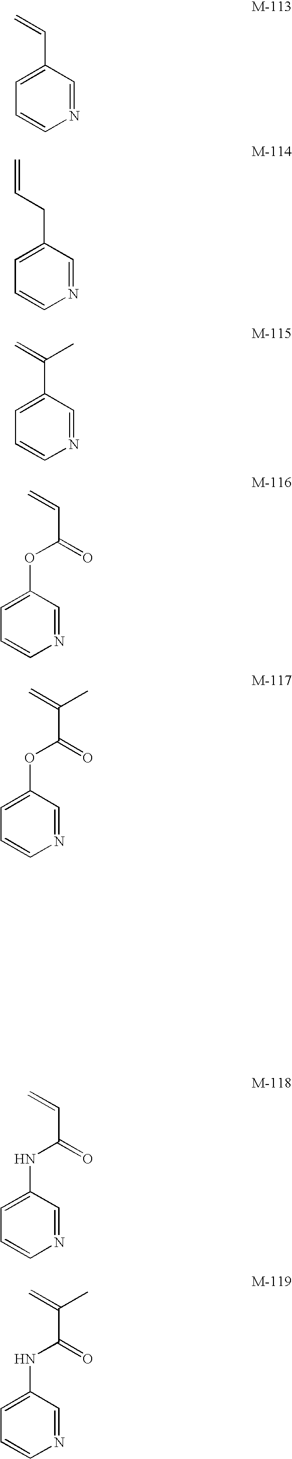

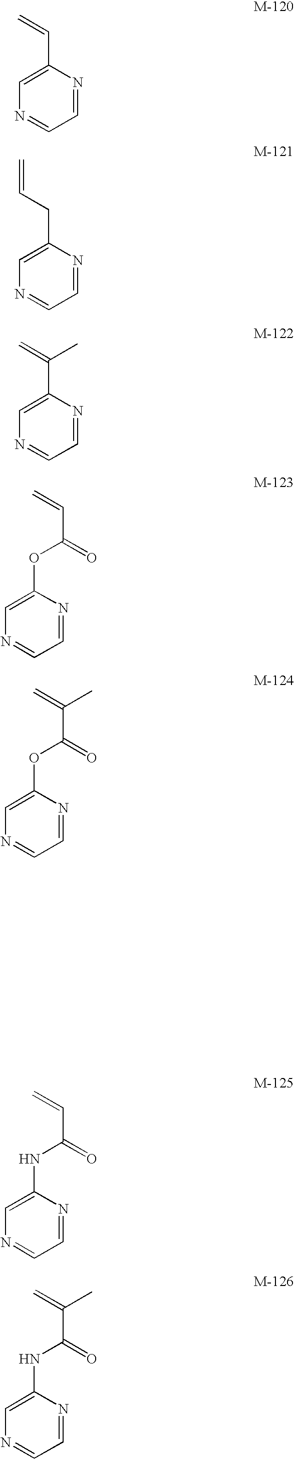

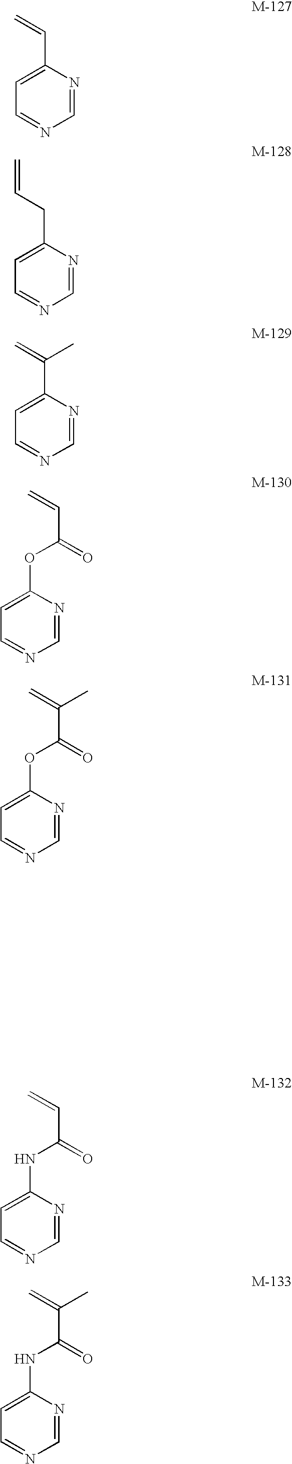

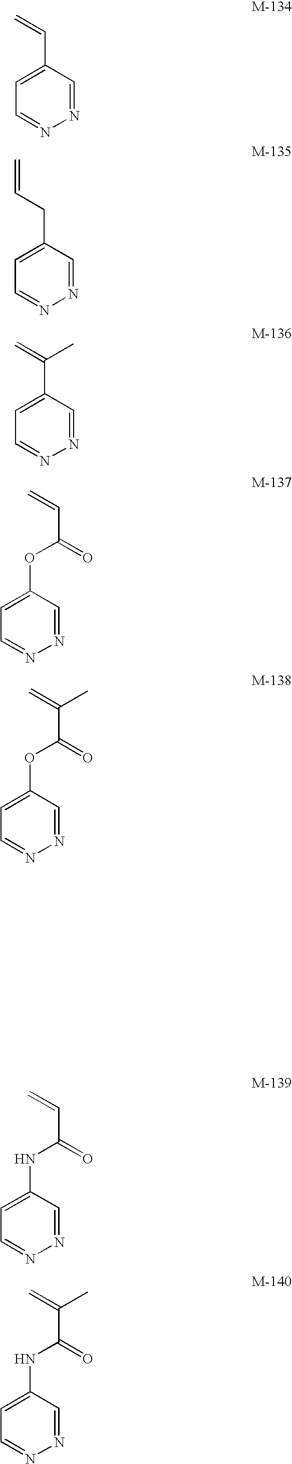

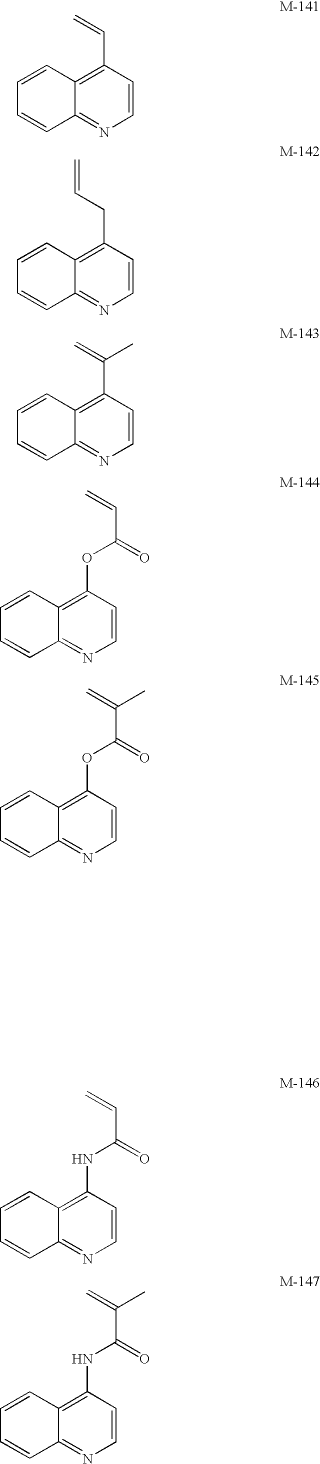

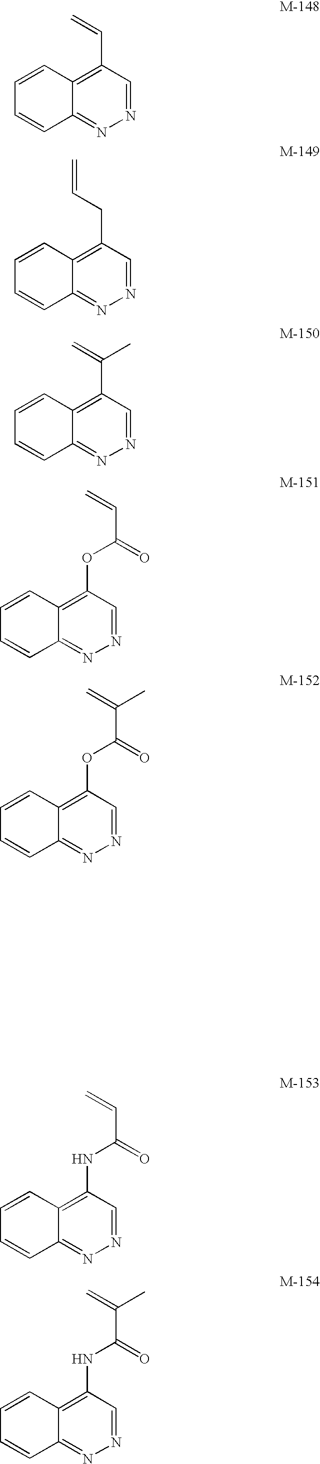

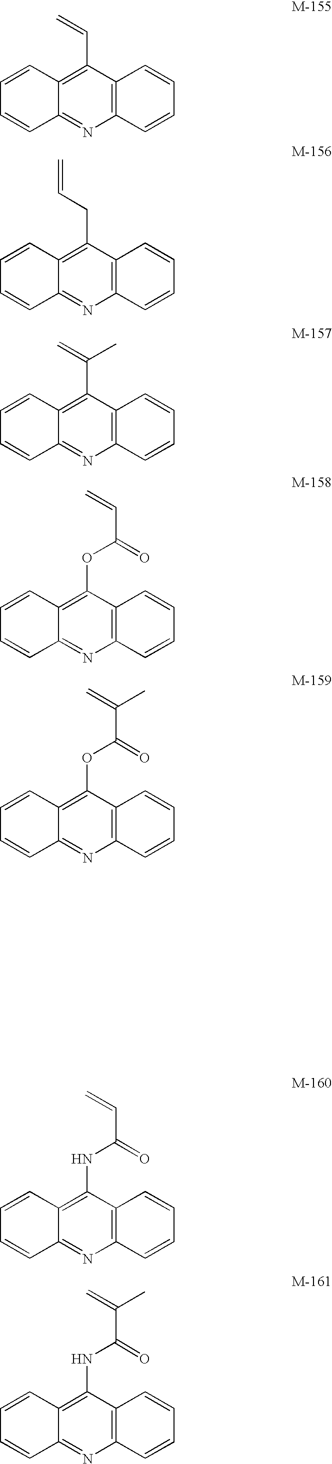

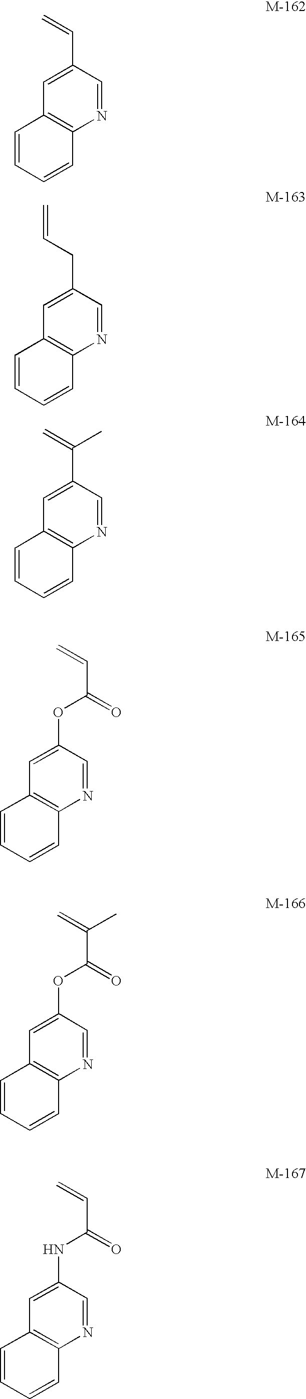

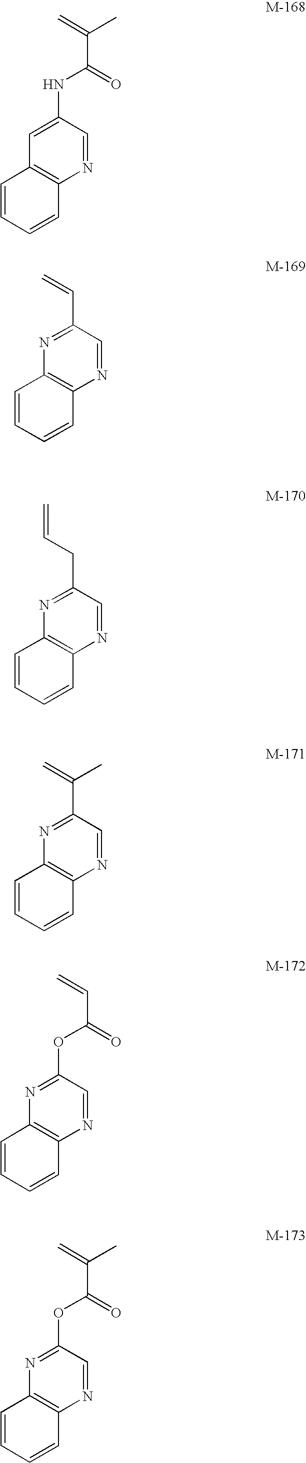

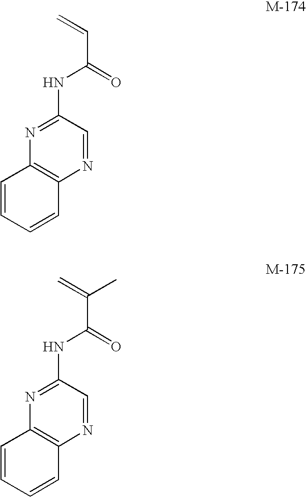

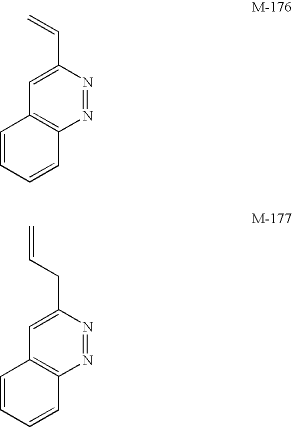

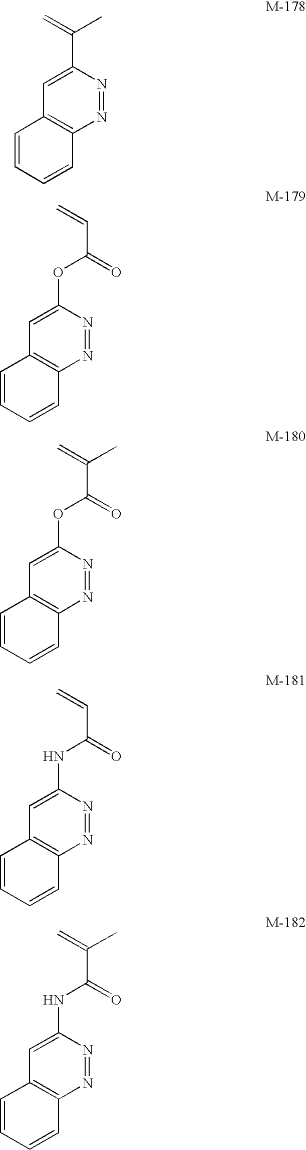

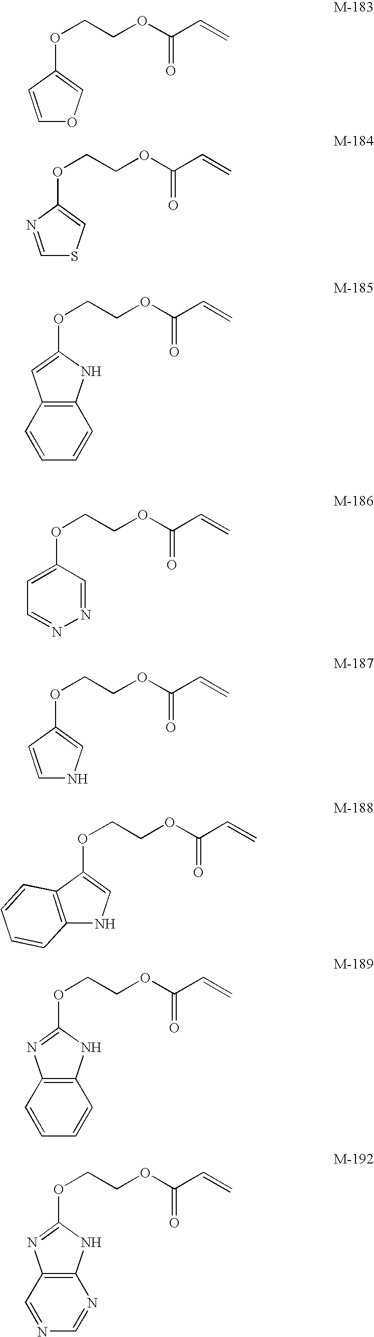

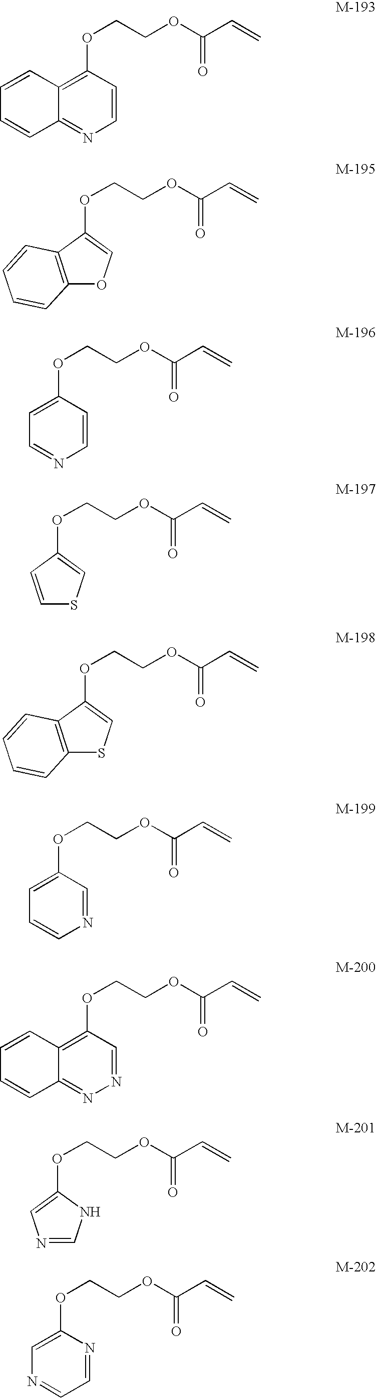

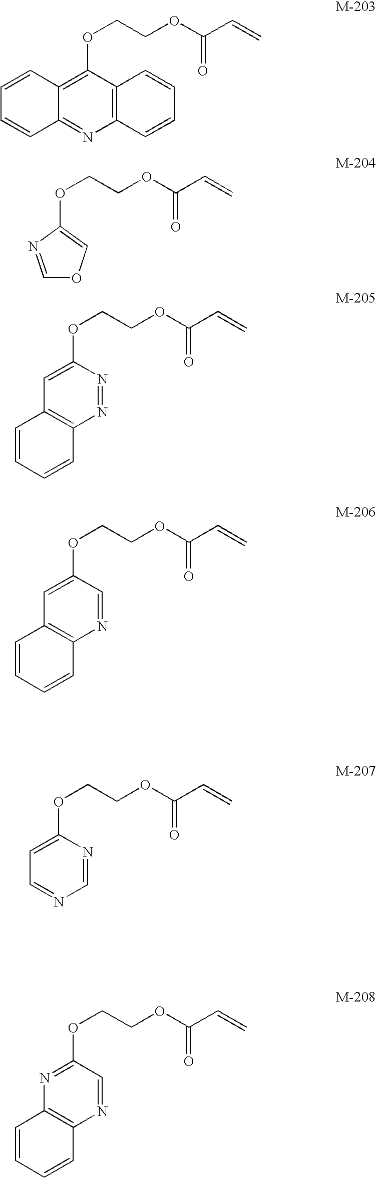

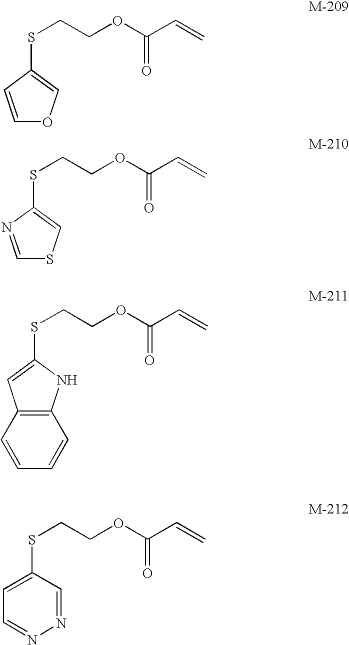

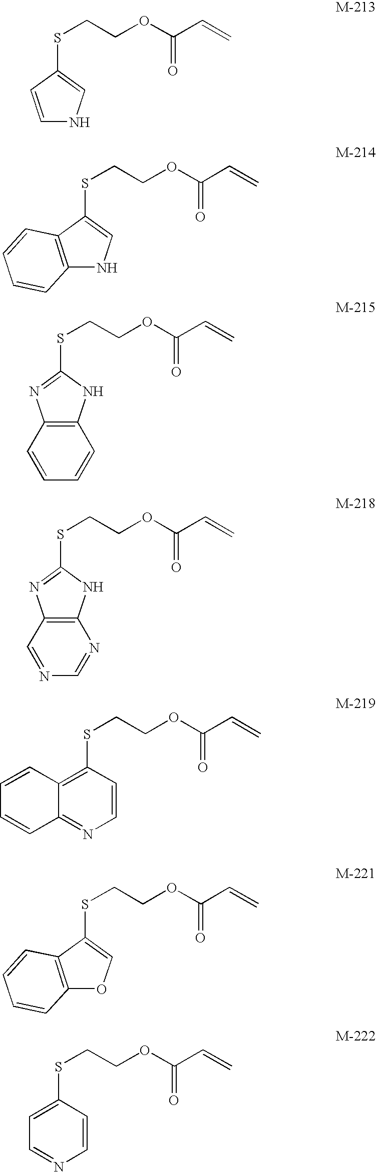

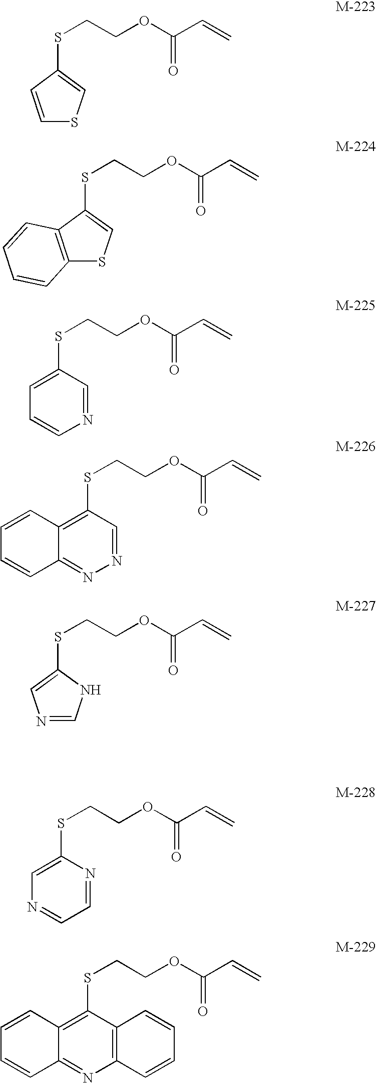

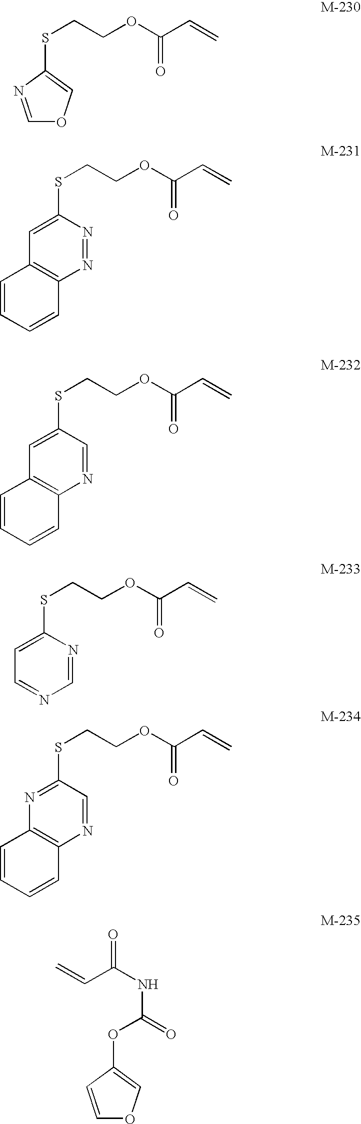

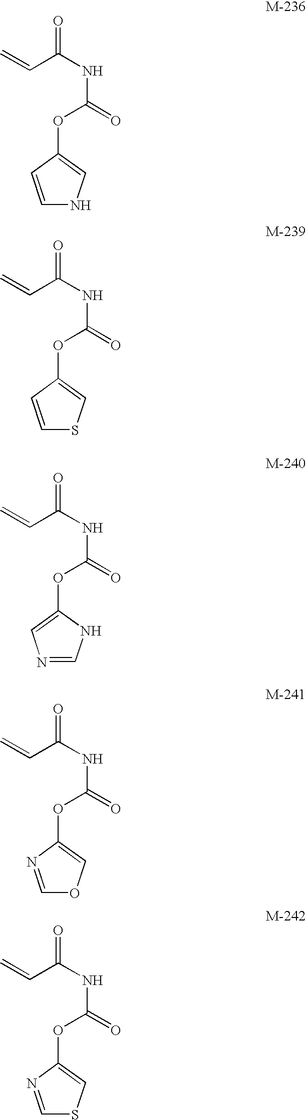

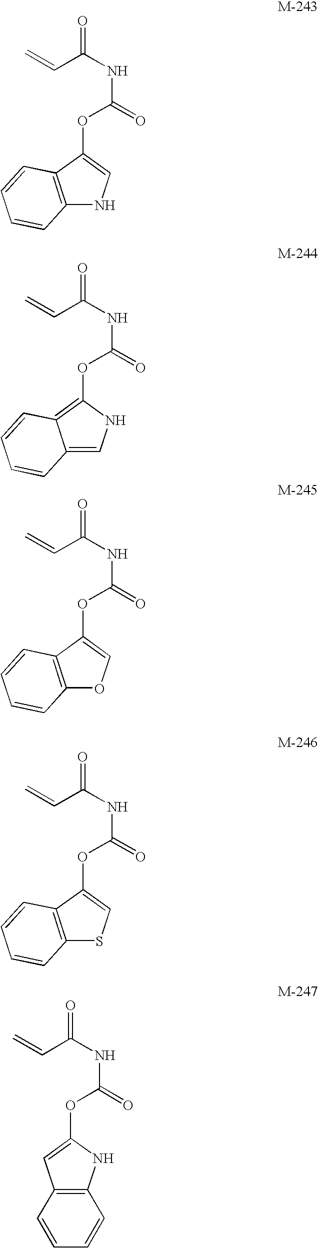

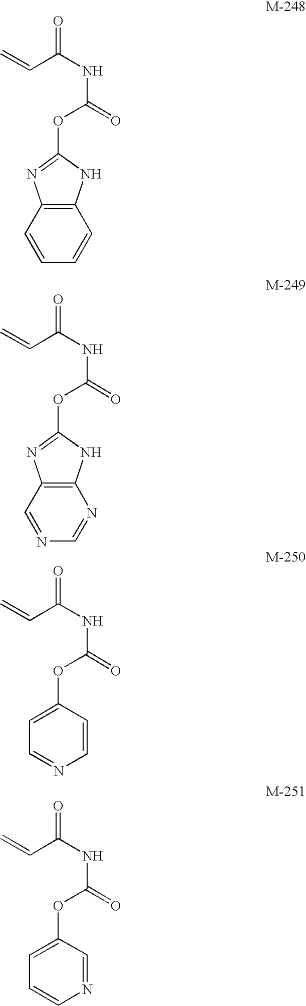

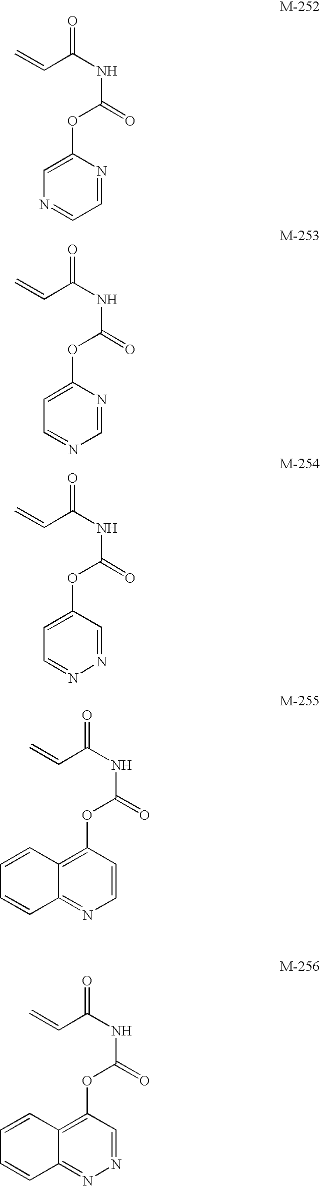

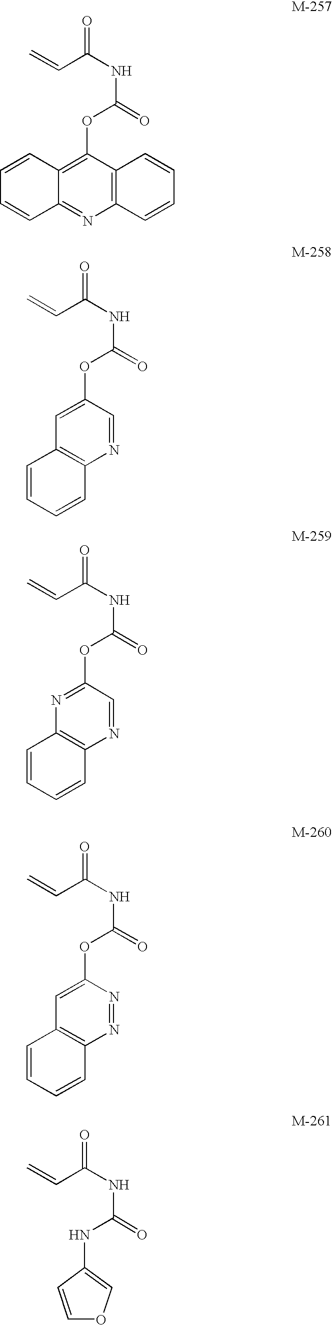

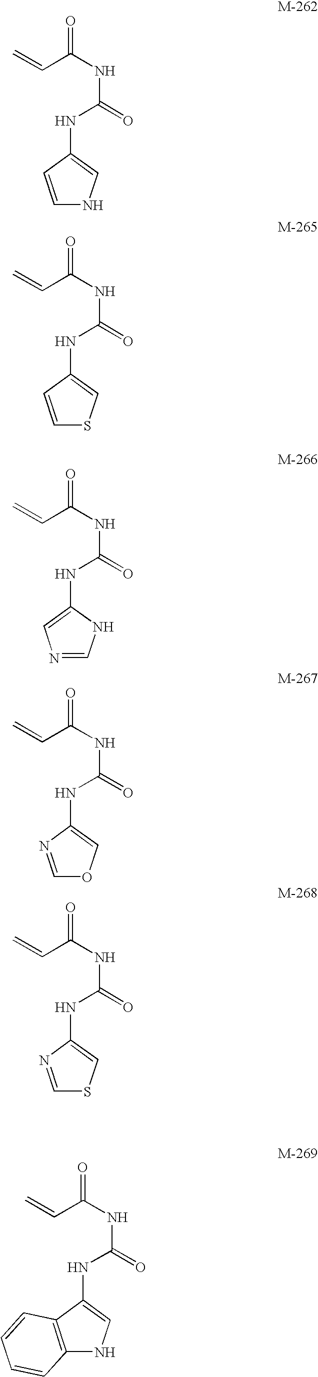

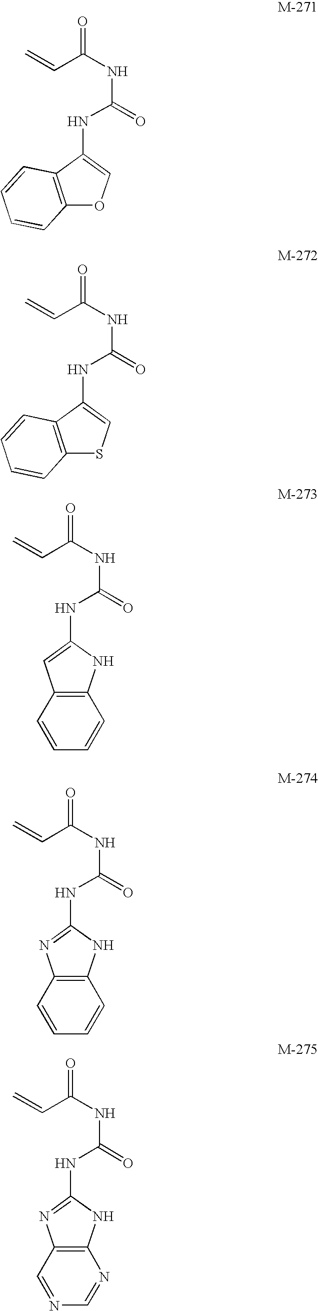

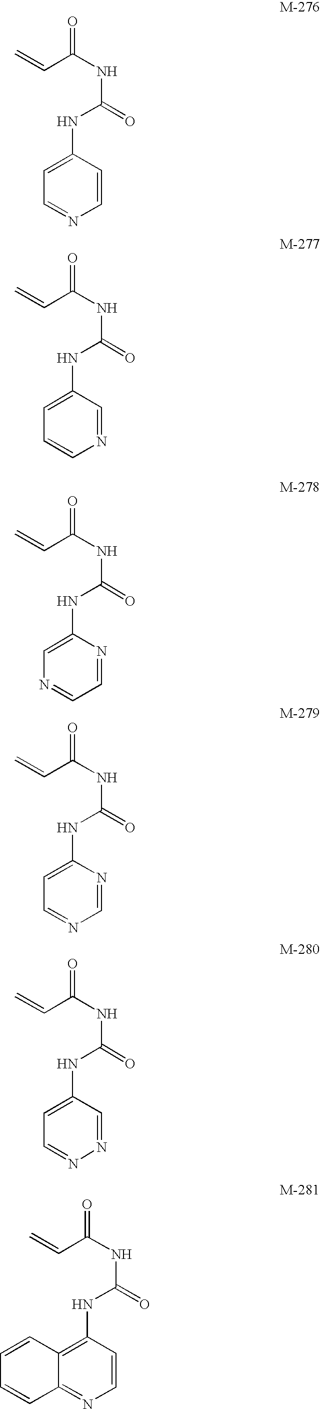

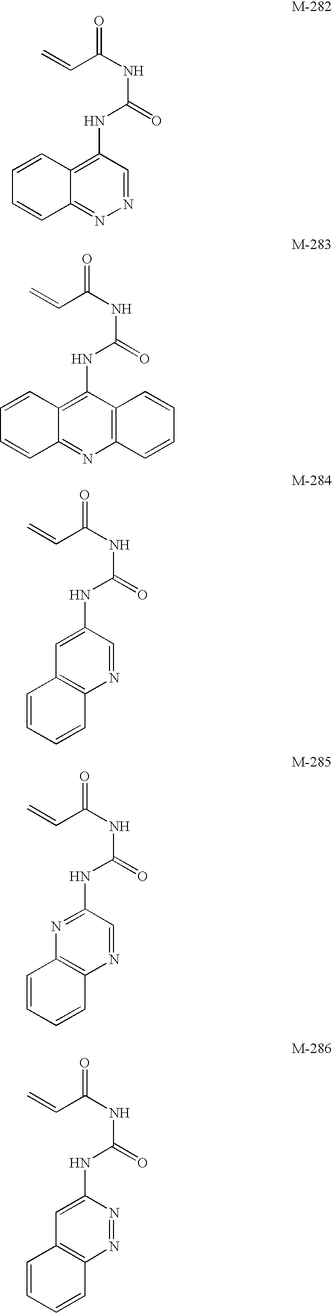

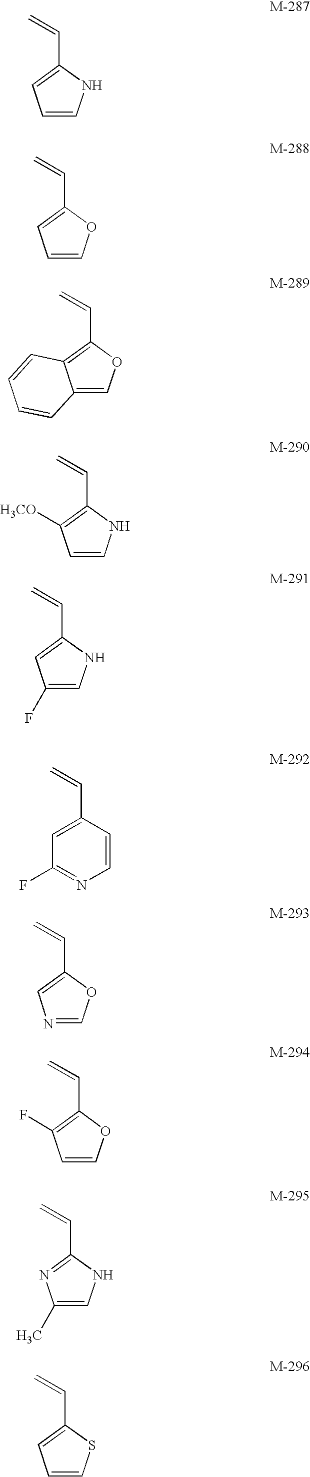

In the specific examples above, as a monomer represented by Formula (1′), (M-1), (M-8), (M-29), (M-106), (M-108), (M-113), and (M-141) are preferable, (M-1), (M-29), (M-106), and (M-108) are more preferable, and (M-106) and (M-108) are yet more preferable.

Furthermore, the molecular weight of the monomer represented by Formula (1′) is preferably 93 to 450, more preferably 93 to 200, and yet more preferably 100 to 150.

The heteroaromatic ring group-containing polymer, which is an essential component of the present invention, may be obtained by subjecting the monomer represented by Formula (1′) to radical polymerization in water and/or a nonaqueous solvent. Furthermore, in order to adjust physical properties of the polymer such as viscosity and surface tension, it may be obtained by copolymerization with another radically polymerizable monomer.

With regard to the radically polymerizable monomer that is copolymerized, a compound that is copolymerizable with a monomer represented by Formula (1′) is used. Specifically, any radically polymerizable compound described in the Polymer Handbook, etc. may be used without particular restrictions; an ethylenically unsaturated bond-containing compound is preferable, and examples thereof include acrylates, methacrylates, and acrylamides. Specific examples include tolyloxyethyl (meth)acrylate, phenyloxyethyl (meth)acrylate, cyclohexyl (meth)acrylate, ethyl (meth)acrylate, methyl (meth)acrylate, ethylene glycol di(meth)acrylate, divinylbenzene, methylene bis(meth)acrylamide, and 1,6-di(meth)acryloyloxyhexane, and preferred examples include tolyloxyethyl (meth)acrylate, ethylene glycol di(meth)acrylate, and 1,6-di(meth)acryloyloxyhexane.

Examples of a polymerization initiator used in polymerization include peroxide-based and azo-based initiators; among them an azo-based initiator is preferable, and specific examples thereof include 2,2′-azobisisobutyronitrile, 2,2′-azobis(2,4-dimethylvaleronitrile), 2,2′-azobis(2,3-dimethylbutyronitrile), 2,2′-azobis(2-methylbutyronitrile), 2,2′-azobis(2,3,3-trimethylbutyronitrile), 2,2′-azobis(2-isopropylbutyronitrile), 1,1′-azobis(cyclohexane-1-carbonitrile), 2,2′-azobis(4-methoxy-2,4-dimethylvaleronitrile), 2-(carbamoylazo)isobutyronitrile, 4,4′-azobis(4-cyanovaleric acid), and dimethyl 2,2′-azobisisobutyrate.

As a solvent used in polymerization, a highly polar solvent is preferable, and specific examples thereof include water, N-methylpyrrolidone, methanol, ethanol, isopropanol, acetonitrile, dimethyl sulfoxide, methyl ethyl ketone, 1-methoxy-2-propanol, and propylene glycol monomethyl ether acetate.

Synthesis of a polymer may be carried out by using the monomer represented by Formula (1′), and as necessary a copolymerizable radically polymerizable monomer and a polymerization initiator. Specifically, there are a method in which a polymerization initiator is added to a mixture of a radically polymerizable monomer and a solvent and a method in which a radically polymerizable monomer and as necessary a polymerization initiator are added dropwise to a solvent, and either of the methods may be used for production. The ‘radically polymerizable monomer’ referred to here means the entire radically polymerizable monomer including a compound represented by Formula (1′) and as necessary a copolymerizable radically polymerizable monomer.

In polymerization, the monomer concentration, relative to the total of the entire polymerizable monomer used in polymerization, the solvent, and the polymerization initiator, is preferably in the range of 5 to 50 wt %, and more preferably 10 to 40 wt %.

The heating temperature in the synthesis is preferably determined according to the decomposition temperature of the polymerization initiator used, and is preferably 30° C. to 120° C., and more preferably 50° C. to 100° C. The polymerization is preferably carried out under a flow of an inert gas such as nitrogen.

With regard to the molar ratio of the monomer represented by Formula (1′) to other copolymerizable radically polymerizable monomers used, the ratio of the monomer represented by Formula (1′) to the total of the other radically polymerizable monomers is preferably 20/80 to 100/0, more preferably 50/50 to 100/0, yet more preferably 85/15 to 100/0, and most preferably 90/10 to 100/0.

In the present invention, the weight-average molecular weight of the heteroaromatic ring group-containing polymer is preferably 3,000 to 300,000, more preferably 3,000 to 200,000, yet more preferably 3,000 to 100,000, and most preferably 5,000 to 20,000.

Specific structures of the heteroaromatic ring group-containing polymer are shown below, but are not limited thereto. The figures in the formulae mean the molar proportion of each monomer component. Mw denotes weight-average molecular weight. Me denotes a methyl group and Ac denotes an acetyl group.

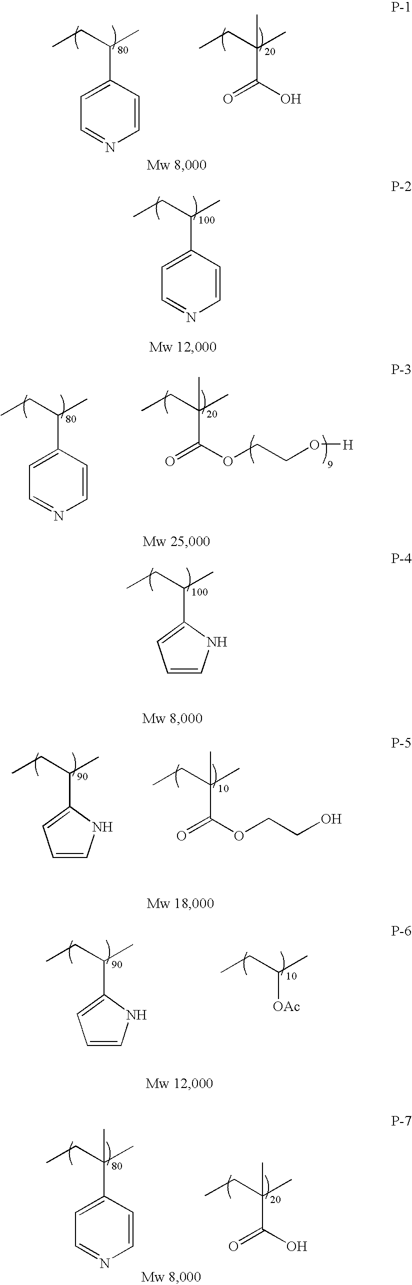

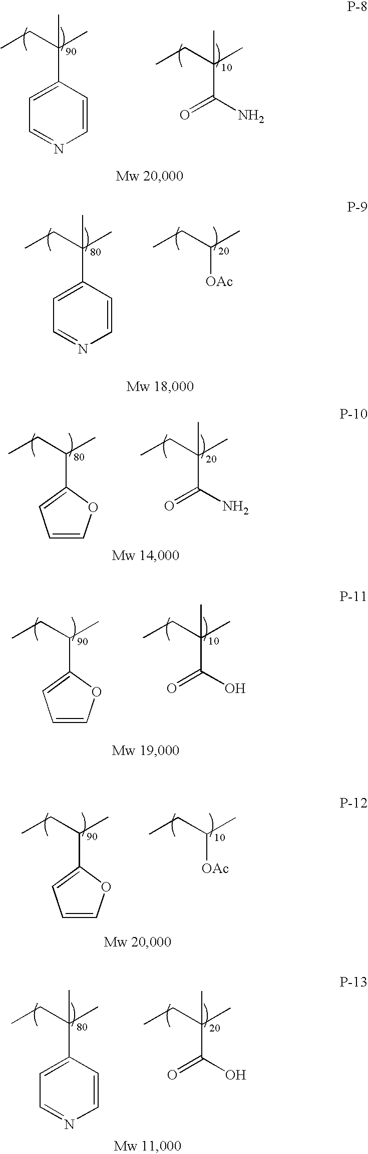

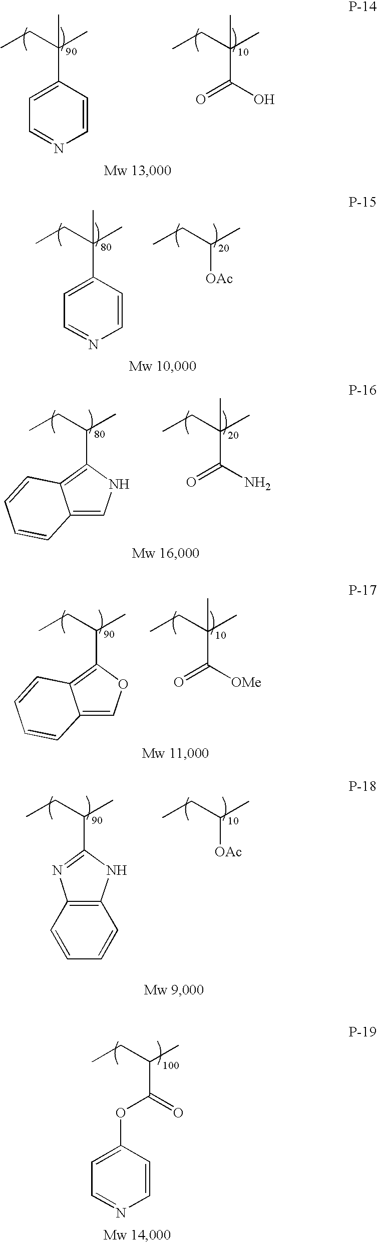

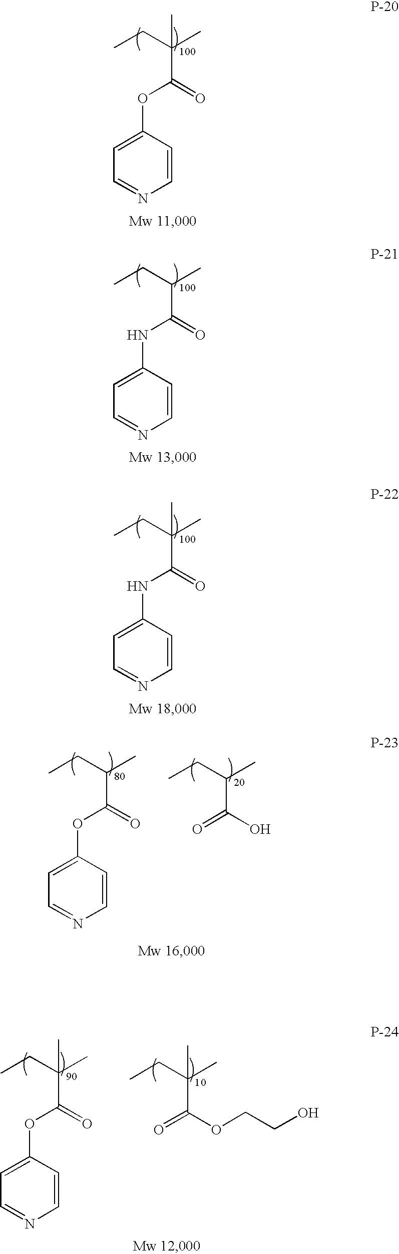

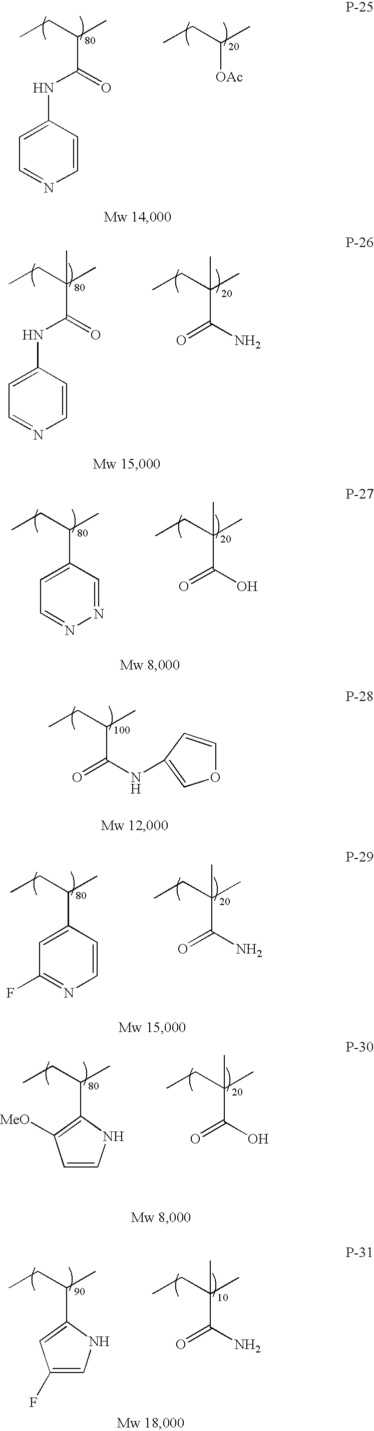

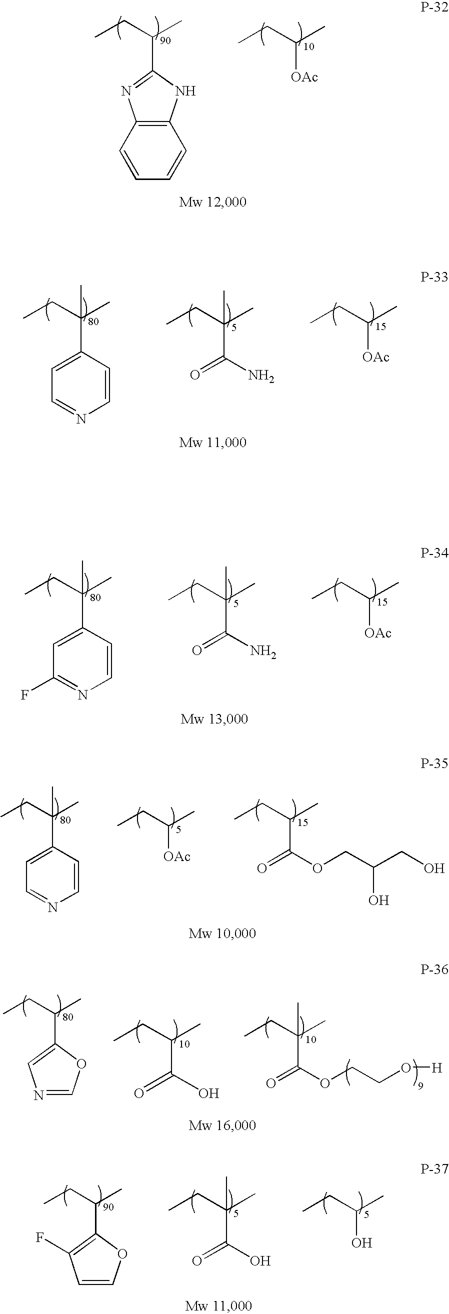

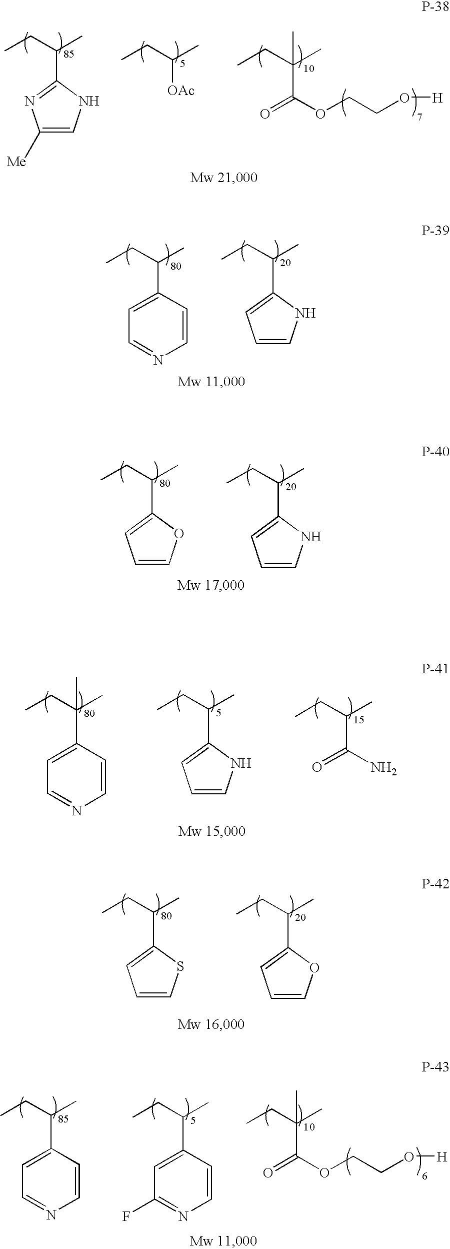

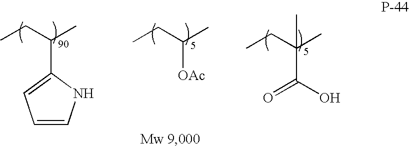

### Colorant

In the present invention, the binder (B) preferably contains a colorant.

Colorants that can be used in the present invention can be broadly divided into dyes and pigments, and dyes are preferably used. With regard to the dyes, the use of subtractive three primaries, that is, yellow (Y), magenta (M), and cyan (C), in addition to black (K) enables a wide range of hues to be reproduced at different saturations. Details are explained below.

### Dye

Dyes used in the present invention include dyes having hues of black, cyan, magenta and yellow. The dye is not particularly limited as long as it is an acid dye, a direct dye, a basic dye, or a disperse dye which is listed in COLOUR INDEX.

Examples of the dye are listed below in terms of color index (C.I.) number, but the present invention should not be construed by being limited thereto.

C. I. Direct Black: 4, 9, 11, 17, 19, 22, 32, 80, 151, 154, 168, 171, 194, 195, etc.

C. I. Direct Blue: 1, 2, 6, 8, 22, 34, 70, 71, 76, 78, 86, 142, 199, 200, 201, 202, 203, 207, 218, 236, 287, etc.

C. I. Direct Red: 1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189, 225, 227, etc.

C. I. Direct Yellow: 1, 2, 4, 8, 11, 12, 26, 27, 28, 33, 34, 41, 44, 48, 86, 87, 88, 132, 135, 142, 144, etc.

C. I. Food Black: 1, 2, etc.

C. I. Acid Black: 1, 2, 7, 16, 24, 26, 28, 31, 48, 52, 63, 107, 112, 118, 119, 121, 172, 194, 208, etc.

C. I. Acid Blue: 1, 7, 9, 15, 22, 23, 27, 29, 40, 43, 55, 59, 62, 78, 80, 81, 90, 102, 104, 111, 185, 254, etc.

C. I. Acid Red: 1, 4, 8, 13, 14, 15, 18, 21, 26, 35, 37, 52, 249, 257, 289, etc.

C. I. Acid Yellow: 1, 3, 4, 7, 11, 12, 13, 14, 19, 23, 25, 34, 38, 41, 42, 44, 53, 55, 61, 71, 76, 79, etc.

C. I. Reactive Blue: 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, 46, etc.

C. I. Reactive Red: 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, 64, 180, etc.

C. I. Reactive Yellow: 1, 2, 3, 4, 6, 7, 11, 12, 13, 14, 15, 16, 17, 18, 22, 23, 24, 25, 26, 27, 37, 42, etc.

C. I. Reactive Black: 1, 3, 4, 5, 6, 8, 9, 10, 12, 13, 14, 18, etc.

Projet Fast Cyan 2 (manufactured by Zeneca Ltd.), Projet Fast Magenta 2 (manufactured by Zeneca Ltd.), Projet Fast Yellow 2 (manufactured by Zeneca Ltd.), Projet Fast Black 2 (manufactured by Zeneca Ltd.), etc. As a matter of course, the present invention is not limited thereto.

As the dye described above, from the viewpoint of inkjet discharge stability, a direct dye or an anionic dye is preferable, and an anionic dye is particularly preferable.

Examples of the anionic dye used suitably in the present invention include those listed below.

### Dyes for Yellow

C. I. Direct Yellow: 1, 2, 4, 8, 11, 12, 26, 27, 28, 33, 34, 39, 41, 44, 48, 50, 58, 85, 86, 87, 88, 89, 98, 100, 110, 132, 135, 142, 144

C. I. Acid Yellow: 1, 3, 4, 7, 11, 12, 13, 14, 17, 19, 23, 25, 29, 34, 36, 38, 40, 41, 42, 44, 53, 55, 61, 76, 79, 98, 99

C. I. Reactive Yellow: 1, 2, 3, 4, 6, 7, 11, 12, 13, 14, 15, 16, 17, 18, 22, 23, 24, 25, 26, 27, 37, 42

C. I. Food Yellow: 3

### Dyes for Magenta

C. I. Direct Red: 1, 2, 4, 8, 9, 11, 13, 15, 20, 23, 24, 28, 31, 33, 37, 39, 46, 51, 59, 62, 63, 73, 75, 79, 80, 81, 83, 87, 89, 90, 95, 99, 101, 110, 189, 197, 201, 218, 220, 224, 225, 226, 227, 228, 229, 230

C. I. Acid Red: 1, 4, 6, 8, 9, 13, 14, 15, 18, 21, 26, 27, 32, 35, 37, 42, 51, 52, 80, 83, 87, 89, 92, 106, 114, 115, 133, 134, 145, 158, 198, 249, 257, 265, 289

C. I. Reactive Red: 1, 2, 3, 4, 5, 6, 7, 8, 11, 12, 13, 15, 17, 19, 20, 21, 22, 23, 24, 28, 29, 31, 32, 33, 34, 35, 36, 37, 38, 39, 40, 41, 42, 43, 44, 45, 46, 47, 48, 49, 50, 58, 59, 63, 64, 180

C. I. Food Red: 87, 92, 94

### Dyes for Cyan

C. I. Direct Blue: 1, 2, 6, 8, 15, 22, 25, 34, 41, 70, 71, 76, 77, 78, 80, 86, 90, 98, 106, 108, 120, 142, 158, 163, 168, 199, 200, 201, 202, 203, 207, 218, 226, 236, 287

C. I. Acid Blue: 1, 7, 9, 15, 22, 23, 25, 27, 29, 40, 43, 55, 59, 62, 74, 78, 80, 81, 90, 100, 102, 104, 111, 117, 127, 138, 158, 161, 185, 254

C. I. Reactive Blue: 1, 2, 3, 4, 5, 7, 8, 9, 13, 14, 15, 17, 18, 19, 20, 21, 25, 26, 27, 28, 29, 32, 33, 34, 37, 38, 39, 40, 41, 43, 44, 46, 100

### Dyes for Black

C. I. Direct Black: 7, 19, 22, 31, 32, 51, 62, 71, 74, 112, 113, 154, 168, 195

C. I. Acid Black: 2, 48, 51, 52, 110, 115, 156

C. I. Food Black: 1, 2

Examples of the direct dye that can suitably be used in the present invention include those listed below.

C. I. Direct Black: 19, 22, 32, 38, 51

C. I. Direct Yellow: 1, 4, 26, 37, 44, 50

C. I. Acid Red: 1, 4, 23, 31, 37, 39, 75, 81

C. I. Direct Blue: 1, 6, 15, 78, 86, 106, 199

Examples of the cationic dye that can suitably be used in the present invention include those listed below.

C.I. Basic Yellow: 1, 2, 11, 13, 14, 19, 21, 25, 32, 33, 36, 51

C.I. Basic Red: 1, 2, 9, 12, 13, 37, 38, 39, 92

C.I. Basic Blue: 1, 3, 5, 7, 9, 19, 24, 25, 26, 28, 29, 45, 54, 65

C.I. Basic Black: 2, 8

With regard to dyes other than the above, those generally used in the field of printing technology (for example, printing inks, heat-sensitive inkjet recording, colorants for copying such as electrostatic photography, and color proofing) can be used.

Examples thereof include dyes described in ‘Senryo Binran’ (Dye handbook) Ed. by The Society of Synthetic Organic Chemistry, Japan, Maruzen Co., Ltd. (1970), ‘Kaisetsu Senryokagaku’ (Explanation of Dye Chemistry), S069. Abeta and K. Imada, Shikisensha Co., Ltd. (1988), ‘Shikiso Handobukku’ (Colorant Handbook), Ed. by M. Ogawara, Kodansha Ltd. (1986), ‘Inkujetto Purinta You Kemikarusu’ (Inkjet Printer Chemicals—Survey of Materials Development Trends and Prospects), CMC Publishing Co., Ltd. (1997), ‘Inkujetto Purinta’ (Inkjet Printers—Technology and Materials), T. Amari, CMC Publishing Co., Ltd. (1998), etc.

### Pigment

The pigment is not particularly limited, and it is possible to use one or more any generally commercially available organic pigment or inorganic pigment dispersed in an insoluble resin, etc. as a dispersion medium, a pigment on the surface of which a resin has been grafted, etc. It is also possible to use resin particles colored with a dye, etc.

The pigment is not particularly limited, and those listed below may be used.

With regard to a black pigment, carbon black is particularly suitable. Examples thereof include carbon black pigments such as furnace black, lamp black, acetylene black and channel black. Specific examples of such carbon black pigments include commercial products such as Raven 7000, Raven 5750, Raven 5250, Raven 5000 ULTRA, Raven 3500, Raven 2000, Raven 1500, Raven 1250, Raven 1200, Raven 1190 ULTRA-II, Raven 1170 and Raven 1255 (produced by Columbian Chemicals Company); Black Pearls L, Regal 400R, Regal 330R, Regal 660R, Mogul L, Monarch 700, Monarch 800, Monarch 880, Monarch 900, Monarch 1000, Monarch 1100, Monarch 1300, Monarch 1400, Monarch 2000 and Valcan XC-72R (produced by CABOT Co.); Color Black FW1, Color Black FW2, Color Black FW2V, Color Black FW18, Color Black FW200, Color Black S150, Color Black S160, Color Black S170, Printex 35, Printex U, Printex V, Printex 140U, Printex 140V, Special Black 6, Special Black 5, Special Black 4A and Special Black 4 (produced by Degussa AG); and No. 25, No. 33, No. 40, No. 47, No. 52, No. 900, No. 2300, MCF-88, MA600, MA7, MA8 and MA100 (produced by Mitsubishi Chemical Corporation), and also include those newly prepared. But the present invention is not limited thereto, and any conventionally-known carbon black may be used. Without being limited to the carbon black, particles of magnetic materials such as magnetite and ferrite, titanium black, etc. may also be used as black pigments.

Specific examples of the organic pigments include insoluble azo pigments such as Toluidine Red, Toluidine Maroon, Hansa Yellow, Benzidine Yellow and Pyrazolone Red; soluble azo pigments such as Lithol Red, Helio Bordeaux, Pigment Scarlet and Permanent Red 2B; derivatives from vat dyes, such as alizarin, indanthorone and thioindigo maroon; phthalocyanine pigments such as Phthalocyanine Blue and Phthalocyanine Green; quinacridone pigments such as Quinacridone Red and Quinacridone Magenta; perylene pigments such as Perylene Red and Perylene Scarlet; isoindolinone pigments such as Isoindolinone Yellow and Isoindolinone Orange; imidazolone pigments such as Benzimidazolone Yellow, Benzimidazolone Orange and Benzimidazolone Red; pyranthrone pigments such as Pyranthrone Red and Pyranthrone Orange; indigo pigments; condensed azo pigments; thioindigo pigments; diketopyrrolopyrrole pigments, Flabanthrone Yellow, Acylamide Yellow, Quinophthalone Yellow; Nickel Azo Yellow, Copper Azomethine Yellow, Perynone Orange, Anthrone Orange, dianthraquinonyl Red and Dioxazine Violet. Naturally, the present invention is not limited thereto, and other organic pigments may also be used.

Examples of the organic pigments used in the present invention, expressed in terms of color index (C.I.) number, include C.I. Pigment Yellow 12, 13, 14, 17, 20, 24, 74, 83, 86, 93, 97, 109, 110, 117, 120, 125, 128, 137, 138, 147, 148, 150, 151, 153, 154, 166, 168, 180 and 185; C.I. Pigment Orange 16, 36, 43, 51, 55, 59, 61 and 71; C.I. Pigment Red 9, 48, 49, 52, 53, 57, 97, 122, 123, 149, 168, 175, 176, 177, 180, 192, 215, 216, 217, 220, 223, 224, 226, 227, 228, 238, 240, 254, 255, and 272; C.I. Pigment Violet 19, 23, 29, 30, 37, 40 and 50; C.I. Pigment Blue 15, 15:1, 15:3, 15:4, 15:6, 20, 60 and 64; C.I. Pigment Green 7 and 36; and C.I. Pigment Brown 23, 25 and 26.

### Solvent

In the present invention, the binder is a dispersion or a solution of the specific polymer and, as necessary, a colorant and/or other additives in a solvent.

The preferred solvent for the above is a water/alcohol mixed solvent. The alcohol is preferably an alcohol having a straight or non-straight chain having 1 to 10 carbons and more preferably an alcohol having a straight or non-straight chain having 1 to 5 carbons (e.g. methanol, ethanol, propanol, isopropanol, and buthanol).

### Other Additive

In addition to the above-mentioned components, another additive such as a surfactant may be freely used in combination in order to improve properties.

In the present invention, the content of the heteroaromatic ring group-containing polymer in the binder, relative to the total weight of the binder, is preferably 1 to 50 wt %, more preferably 1 to 30 wt %, and yet more preferably 1 to 20 wt %.

In the present invention, the solids content concentration of the binder, relative to the total weight of the binder, is preferably 1 to 60 wt %, more preferably 1 to 40 wt %, and most preferably 1 to 30 wt %.

### II. Process for Producing Three-Dimensional Model and Three-Dimensional Model

The process for producing a three-dimensional model of the present invention comprises sequentially repeating a layer formation step of forming on a support a layer of a powder material, the layer having a predetermined thickness, and a bonding step of bonding the powder material in the layer with a binder so as to give a cross-sectional shape of a modeled object that has been sectioned into parallel cross-sections, the material for three-dimensional modeling of the present invention being used as the powder material and the binder.

In the bonding step, it is preferable for the binder to be discharged by inkjet.

The process for producing a three-dimensional model of the present invention is explained below with reference to drawings.

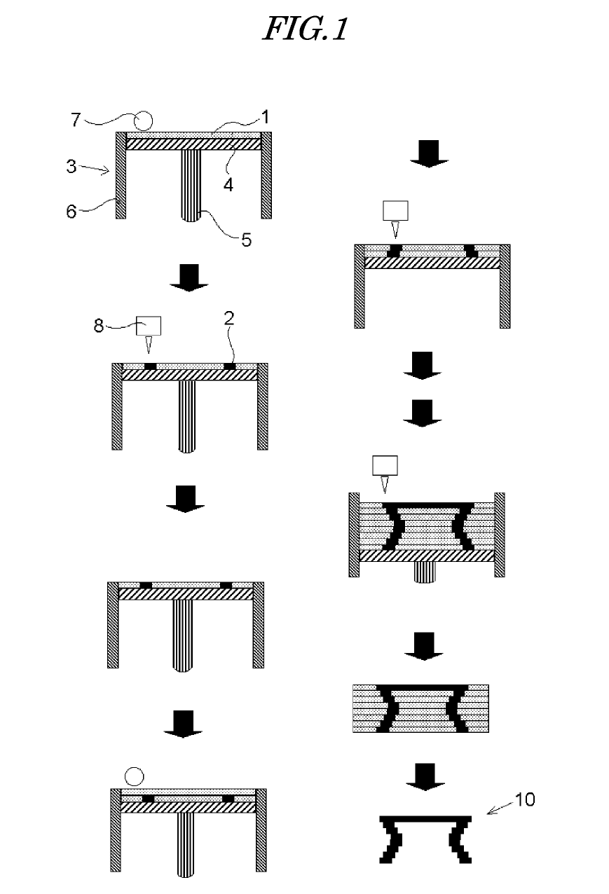

FIG. 1 is a schematic view showing the main steps of one embodiment of the process for producing a three-dimensional model of the present invention.

In the production process of the present invention, a thin layer 1 of a powder material is formed on a support (modeling stage) 4 provided in a three-dimensional modeling section 3. The support 4 is supported by a vertically moving section 5 and its perimeter is surrounded by a frame 6. The thin layer 1 is formed by moving a blade 7 over surplus powder material, which is supplied to the support 4 from a powder supply section, in a direction X (left-to-right direction in the plane of the paper), the blade 7 extending lengthwise in a direction Y (direction perpendicular to the plane of the paper). A binder is supplied to the top of the thus-formed thin layer 1 of the powder material, via an inkjet head 8 of a binder application section, according to cross-sectional shape data so as to form a region 2 to which the binder has been applied. This region 2 to which binder has been applied is cured by evaporating moisture by drying means, thereby bonding the powder material in the region 2 to which binder has been applied throughout the entire thin layer thickness to thus form a cross-sectional shape and bonding it to a cross-sectional shape immediately therebeneath. With regard to the drying means, the entire section of the three-dimensional modeling is covered with a hood, which is not illustrated, and the temperature within the hood is adjusted by a hot air dryer.

Subsequently, the vertically moving section 5 is moved downward by 1 slice pitch, and a new powder material layer is formed.

Binder is supplied to the top of the newly formed thin layer via the inkjet head 8 of the binder application section according to the adjacent next cross-sectional shape data so as to form a new region 2 to which binder has been applied. This region is cured by drying with the drying means, thus bonding the powder material.

After sequentially repeating formation of the powder material thin layer 1, supply of the binder, and drying/curing a required number of times, a three-dimensional model 10 can be obtained by separating the powder material in a region where no binder has been applied.

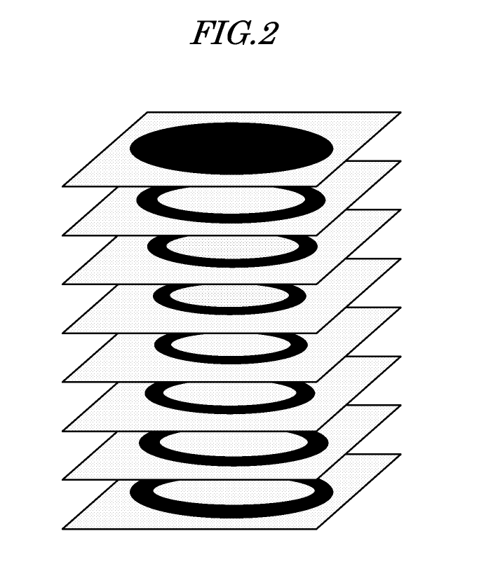

FIG. 2 is a perspective view showing schematically the cross-sectional shape formed in each of the adjacent layers in the production of the above-mentioned three-dimensional model.

A preferred embodiment of the process for producing a three-dimensional model of the present invention is explained below. The five steps below include a step of forming three-dimensional shape color data and a step of forming colored cross-sectional shape data for each cross section, prior to the (powder) layer formation step and the bonding step (hereinafter, also called a cross-sectional shape formation step).

In a first step, model data representing a three-dimensional modeled object having on its surface a color pattern, etc. are formed in a computer. As model data used as a basis for modeling, color three-dimensional model data formed by general 3D-CAD modeling software can be used. It is also possible to utilize data and texture of a three-dimensional colored shape measured using a three-dimensional shape input device.

In a second step, cross-sectional data for each horizontally sliced cross section of the modeled object are formed in a computer from the above-mentioned model data. A cross-sectional body sliced at a pitch (layer thickness t) corresponding to the thickness of one layer of the powder to be layered is cut out of the model data, and shape data and coloration data showing a region where the cross section is present are formed as the cross-sectional data. In the present invention, ‘shape data’ and ‘coloration data’ are together also called ‘colored (cross-sectional) shape data’.

Subsequently, information regarding the layer thickness (slice pitch when forming the cross sectional data) of the powder and the number of layers (the number of sets of colored shape data) when modeling a modeled object is input from the computer into a drive control section of a pattern formation device.

In a third step, supply of a powder material, which is the material for producing the three-dimensional model on the modeling stage, is carried out. The powder material is spread in a uniformly thick layer shape using a powder material counter-rotating mechanism, and supply of the powder material is stopped when a predetermined amount of powder has been supplied.

‘Sequentially repeating the layer formation step and the cross-sectional shape formation step’ referred to in the present invention means not only (1) carrying out a step of forming a cross-sectional shape on the whole surface of a new layer after completing a new layer formation step, but also (2) forming a cross-sectional shape in a region of a newly formed layer before formation of the newly formed layer is completed, while still carrying out the new layer formation step. An example of the latter case has been disclosed in JP-A-2002-307562.

A fourth step is a step of forming a colored cross-sectional shape under the control of the drive control section according to the colored shape data for the cross section. This step preferably employs a non-contact method. As a representative example, an inkjet method is explained.

The shape data and the coloration data created in the second step are converted into finely divided grids of bitmap information for each color of C, M, and Y, and an inkjet head is moved within an XY plane. During the movement, a binder is discharged appropriately from each inkjet discharge nozzle based on the coloration data. As the binder, two or more types of binders selected from the group consisting of at least one type of colored binder, a white binder, and a colorless transparent binder are used.

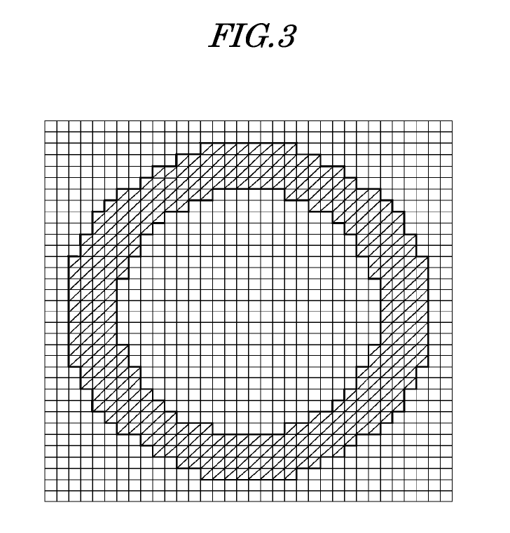

FIG. 3 is a plan view showing one example of finely divided grid cross-sectional data generated in the second step. In FIG. 3, the hatched grids correspond to regions where binder is discharged. The discharge scaling factor for grid points positioned in the outermost layer of the model may be increased. For cross-sectional shapes partway through the process, a larger amount of binder is preferably discharged to the outline grid points corresponding to the outer surface than is discharged to the internal grid points. The discharge scaling factor can be increased up to adjacent grid points of several grid divisions adjacent to an outline grid point. The ‘several adjacent grids’ are preferably 1 to 10 grid divisions, and more preferably 1 to 5 grid divisions.

Adjustment of the discharge scaling factor can be carried out by changing the amount of discharge per unit time and/or increasing the number of times of discharge at the same grid point.

It is preferable to increase the discharge scaling factor of the outline grid points alone since control is simple. For example, the discharge scaling factor for the outline grid points alone is made 2 times that for the internal grid points, etc. It is also possible to set the discharge scaling factor of every other adjacent grid point to be 2 times. Control of the number of times of discharge is more simple than control of the amount discharged per unit time. In one preferred embodiment, for example, the amounts discharged for the outline grid points and one layer of adjacent grid points are increased by adjusting the number of times of discharge to once, twice, or three times.

By adjusting the amount of binder discharged per unit time to 0.66 to 1.5 times, the discharge scaling factor can be adjusted more finely. Combining this with adjustment of the number of times of discharge onto 1 grid point, adjustment of the discharge scaling factor can be carried out even more finely.

When the amount discharged onto an outline grid point is increased, the binder spreads beyond a predetermined region, and there is a tendency for the surface smoothness of the three-dimensional model obtained to be impaired. In such a case, spreading of the binder can be prevented by a measure in which a spread-preventing liquid that is not compatible with the binder is disposed along the outline outside the outline grid points of the cross-sectional shape of the model.

With regard to the colored binders, a combination of the three colors of yellow (Y), magenta (M), and cyan (C), which are subtractive primaries, is preferable. In the present invention, a yellow-colored binder is called a ‘yellow binder’, a magenta-colored binder is called a ‘magenta binder’, and a cyan-colored binder is called a ‘cyan binder’. An M dye and a C dye may each comprise two, that is, dark- and pale-colored, types of binders. The colorless binder can be used in order to adjust the CMY color densities. Furthermore, a desired effect can be attained by the combined use of a binder (white binder) containing a white pigment such as titanium white or a black dye-colored binder (black binder).

The total amount of colored binder, colorless binder, and white binder discharged is preferably constant per unit area, for example, per grid point or per 4 adjacent grid points. As hereinbefore described, it is preferable that the total amount of binder in the outline grid points is larger than that in the internal grid points.

As another example of the step of forming a colored cross-sectional shape, it is possible to employ a two-stage step in which, after a colorless ultraviolet-curing binder alone is discharged onto a powder material according to shape data and cured by ultraviolet irradiation, a normal CMY inkjet containing no binder is discharged on the bonded powder material layer according to the coloration data for the layer. In this case, it is preferable that the discharge scaling factor for the colorless binder is higher in the outline grid points.

By evaporating a volatile component such as moisture or a solvent in the binder by drying means at the same time as or after discharge of the binder, a cross-sectional shape, which is a bonded body of the powder material, is formed.

By maintaining the modeling section at about 35° C. to 40° C., a volatile component such as moisture or a solvent present in the binder can be evaporated, thus carrying out drying.

By sequentially repeating the third and fourth steps, a three-dimensional model formed by sequentially forming layers of bonded colored powder material bodies corresponding to cross sections obtained by sectioning the modeled object in a plurality of planes can thus be produced.

In a powder material region to which no binder is applied, the powder particles retain their independent state.

In a fifth step, the powder material in a region to which no binder has been applied is separated, and a bonded powder body (three-dimensional model) bonded by the binder is taken out. The powder material that has not been bonded is recovered and can be reused.

In accordance with the present invention, there can be provided a material for three-dimensional modeling that has good inkjet discharge suitability and good liquid penetration and gives a three-dimensional model having high strength, a process for producing a three-dimensional model, and a three-dimensional model produced by the production process.

### EXAMPLES

The present invention is explained below with reference to Examples, but the present invention is not limited by these Examples. In the Examples and Comparative Examples below, ‘parts’ means ‘parts by weight’ and ‘%’ means ‘wt %’ unless otherwise specified.

### Synthetic Example (1)

### Synthesis of Polymer FP-1 Having a Heteroaromatic Ring Group

100 parts of 4-vinylpyridine (Exemplary monomer (M-106) (the monomer represented by (M-106))) was dissolved in N-methylpyrrolidone to give a 20 wt solution, heated to 80° C. under a flow of nitrogen, and was stirred for 1 hour. One part of dimethyl 2,2′-azobisisobutyrate was added thereto, and stirring was then carried out for 2 hours. Then the temperature was raised to 90° C., one part of dimethyl 2,2′-azobisisobutyrate was added, and stirring was carried out for a further 2 hours. Thereafter, the resultant mixture was allowed to cool to room temperature, and after precipitation and washing with ethyl acetate, polymer FP-1 was obtained as a white powder by drying under reduced pressure. The rate of polymerization of the resultant white powder was 97% and the weight-average molecular weight (Mw) thereof was 10,000.

### Synthetic Example (2)

### Synthesis of Polymer FP-2 Having a Heteroaromatic Ring Group

Polymer FP-2 was obtained as a white powder in the same manner as Synthetic example (1) except that 100 parts of 3-vinylfuran (Exemplary monomer (M-1)) was used instead of 100 parts of 4-vinylpyridine (Exemplary monomer (M-106)). The rate of polymerization of the resultant white powder was 97% and the weight-average molecular weight thereof was 12,000.

### Synthetic Example (3)

### Synthesis of Polymer FP-3 Having a Heteroaromatic Ring Group

Polymer FP-3 was obtained as a white powder in the same manner as Synthetic example (1) except that 100 parts of 3-vinylthiophene (Exemplary monomer (M-29)) was used instead of 100 parts of 4-vinylpyridine (Exemplary monomer (M-106)). The rate of polymerization of the resultant white powder was 97% and the weight-average molecular weight thereof was 11,000.

### Synthetic Example (4)

### Synthesis of Polymer FP-4 Having a Heteroaromatic Ring Group

90 parts of pyridine-4-acrylamide (Exemplary monomer (M-111)) and 10 parts of methyl methacrylate were dissolved in N-methylpyrrolidone to give a 30 wt % solution, heated to 80° C. under a flow of nitrogen, and was stirred for 1 hour. One part of dimethyl 2,2′-azobisisobutyrate was added thereto, and stirring was then carried out for 2 hours. Then the temperature was raised to 90° C., one part of dimethyl 2,2′-azobisisobutyrate was added, and stirring was carried out for a further 2 hours. After the reaction, the resultant mixture was allowed to cool to room temperature, and after precipitation and washing with ethyl acetate, polymer FP-4 was obtained as a white powder by drying under reduced pressure. The rate of polymerization of the resultant white powder was 96% and the weight-average molecular weight thereof was 11,000.

### Synthetic Example (5)

### Synthesis of Polymer FP-5 Having a Heteroaromatic Ring Group

Polymer FP-5 was obtained as a white powder in the same manner as Synthetic example (4) except that 50 parts of 4-vinylpyridine (Exemplary monomer (M-106)) and 50 parts of acrylamide were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 12,000.

### Synthetic Example (6)

### Synthesis of Polymer FP-6 Having a Heteroaromatic Ring Group

Polymer FP-6 was obtained as a white powder in the same manner as Synthetic example (4) except that 20 parts of 4-vinylpyridine (Exemplary monomer (M-106)) and 80 parts of acrylamide were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 14,000.

### Synthetic Example (7)

### Synthesis of Polymer FP-7 Having a Heteroaromatic Ring Group

Polymer FP-7 was obtained as a white powder in the same manner as Synthetic example (4) except that 90 parts of 4-vinylpyridine (Exemplary monomer (M-106)), 8 parts of acrylamide, and 2 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 12,000.

### Synthetic Example (8)

### Synthesis of Polymer FP-8 Having a Heteroaromatic Ring Group

90 parts of 4-vinylpyridine (Exemplary monomer (M-106)) and 10 parts of acrylamide were dissolved in N-methylpyrrolidone to give a 40 wt % solution, heated to 80° C. under a flow of nitrogen, and was stirred for 1 hour. One part of dimethyl 2,2′-azobisisobutyrate was added thereto, and stirring was then carried out for 2 hours. Then the temperature was raised to 90° C., one part of dimethyl 2,2′-azobisisobutyrate was added, and stirring was carried out for a further 2 hours. After the reaction, the resultant mixture was allowed to cool to room temperature, and after precipitation and washing with ethyl acetate, polymer FP-8 was obtained as a white powder by drying under reduced pressure. The rate of polymerization of the resultant white powder was 99% and the weight-average molecular weight thereof was 120,000.

### Synthetic Example (9)

### Synthesis of Polymer FP-9 Having a Heteroaromatic Ring Group

90 parts of 4-vinylpyridine (Exemplary monomer (M-106)) and 10 parts of acrylamide were dissolved in N-methylpyrrolidone to give a 50 wt % solution, heated to 80° C. under a flow of nitrogen, and was stirred for 1 hour. One part of dimethyl 2,2′-azobisisobutyrate was added thereto, and stirring was then carried out for 2 hours. Then the temperature was raised to 90° C., one part of dimethyl 2,2′-azobisisobutyrate was added, and stirring was carried out for a further 2 hours. After the reaction, the resultant mixture was allowed to cool to room temperature, and after precipitation and washing with ethyl acetate, polymer FP-9 was obtained as a white powder by drying under reduced pressure. The rate of polymerization of the resultant white powder was 99% and the weight-average molecular weight thereof was 200,000.

### Synthetic Example (10)

### Synthesis of Polymer FP-10 Having a Heteroaromatic Ring Group

Polymer FP-10 was obtained as a white powder in the same manner as Synthetic example (4) except that 90 parts of furan-3-acrylamide (Exemplary monomer (M-6)) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 70,000.

### Synthetic Example (11)

### Synthesis of Polymer FP-11 Having a Heteroaromatic Ring Group

Polymer FP-11 was obtained as a white powder in the same manner as Synthetic example (4) except that 100 parts of thiophene-3-acrylamide (Exemplary monomer (M-6)) was used instead of 90 parts of pyridine-4-acrylamide (Exemplary monomer (M-111)) and 10 parts of methyl methacrylate. The rate of polymerization of the resultant white powder was 99% and the weight-average molecular weight thereof was 50,000.

### Synthetic Example (12)

### Synthesis of Polymer FP-12 Having a Heteroaromatic Ring Group

Polymer FP-12 was obtained as a white powder in the same manner as Synthetic example (4) except that 90 parts of Exemplary monomer (M-268) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 58,000.

### Synthetic Example (13)

### Synthesis of Polymer FP-13 Having a Heteroaromatic Ring Group

Polymer FP-13 was obtained as a white powder in the same manner as Synthetic example (4) except that 90 parts of Exemplary monomer (M-230) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 56,000.

### Synthetic Example (14)

### Synthesis of Polymer FP-14 Having a Heteroaromatic Ring Group

Polymer FP-14 was obtained as a white powder in the same manner as Synthetic example (4) except that 90 parts of Exemplary monomer (M-192) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 61,000.

### Synthetic Example (15)

### Synthesis of Polymer FP-15 Having a Heteroaromatic Ring Group

Polymer FP-15 was obtained as a white powder in the same manner as Synthetic example (4) except that 90 parts of Exemplary monomer (M-186) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 64,000.

### Synthetic Example (16)

### Synthesis of Polymer FP-16 Having a Heteroaromatic Ring Group

Polymer FP-16 was obtained as a white powder in the same manner as Synthetic example (4) except that 90 parts of Exemplary monomer (M-283) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 62,000.

### Synthetic Example (17)

### Synthesis of Polymer FP-17 Having a Heteroaromatic Ring Group

Polymer FP-17 was obtained as a white powder in the same manner as Synthetic example (4) except that 90 parts of Exemplary monomer (M-281) and 10 parts of methyl methacrylate were used instead of 90 parts of pyridine-4-acrylamide (Exemplary monomer (M-111)) and 10 parts of methyl methacrylate. The rate of polymerization of the resultant white powder was 99% and the weight-average molecular weight thereof was 64,000.

### Production of Material for Three-Dimensional Modeling

### Material for Three-Dimensional Modeling: Binder T-1

An inkjet discharge material (binder) for three-dimensional modeling was obtained by stirring the components below by means of a stirrer.

Polymer FP-1: 10 parts
Water: 20 parts
Methanol: 60 parts
C.I. Acid Red 1: 10 parts

### Materials for Three-Dimensional Modeling: Binders T-2 to T-26

Binders T-2 to T-26 were obtained in the same manner as for binder T-1 except that polymer FP-1 and C.I. Acid Red 1 were changed as shown in Table 1.

### Evaluation Methods

### Production of Three-Dimensional Model

Hi Pearl M4003 (polymethyl methacrylate resin, average particle size 70 μm, Negami Chemical Industrial Co.) as organic particles (powder material) was laid down using a coating blade and a lower/raise stage so as to give a powder material thickness of 800 μm, and droplets of a material for three-dimensional modeling (binder) were fired thereonto using a JETMASTER2 non-contact type dispenser (Musashi Engineering, Inc.) and a SHOT mini SL desktop 3-axis robot (Musashi Engineering, Inc.) in a region of 2.5 cm length×2.6 cm width by 28 G nozzles with a pressure of 0.15 to 0.20 MPa at intervals of 0.5 mm a total of 2,600 times, 50 times lengthwise and 52 times widthwise. After penetration, laying down of Hi Pearl M4003 as organic particles using the coating blade and the lower/raise stage so as to give a thickness of 800 μm and droplet firing were repeated a total of 4 times, thus producing a plate that was 2.5 cm long×2.6 cm wide×3.2 mm high.

### Evaluation of Strength

Stands spaced by a gap of 1 cm were bridged by the plate thus produced so that the center of the plate coincided with the center of the gap, a load was applied to the center of the plate using an iron column having a diameter of 5 mm, and the evaluation and scoring below were carried out from the maximum pressure that the plate could withstand before breaking.

Pressure resistance at least 500 gw: 5 points
Pressure resistance at least 400 gw to but less than 500 gw: 4 points
Pressure resistance at least 300 gw to but less than 400 gw: 3 points
Pressure resistance at least 200 gw to but less than 300 gw: 2 points
Pressure resistance at least 100 gw to less than 200 gw: 1 point
Pressure resistance less than 100 gw: 0 points

### Evaluation of Discharge Stability

The scoring below was carried out from the number of times of nozzle blockage (state in which modeling could not be continued unless the nozzle was cleaned with methanol) when a three-dimensional model was produced by the above-mentioned method. After the nozzle was blocked, modeling was suspended, the nozzle was washed, and modeling was restarted.

Nozzle blocked 0 times: 5 points
Nozzle blocked 1 time: 4 points
Nozzle blocked 2 times: 3 points
Nozzle blocked 3 times: 2 points
Nozzle blocked 4 times: 1 point
Nozzle blocked 5 or more times: 0 points

### Evaluation of Liquid Penetration

0.1 mL of a modeling material was dropped onto Hi Pearl M4003 by means of a syringe so that the surface was not disturbed, and the scoring below was carried out using the time taken for the contact angle on the surface of the dropped liquid measured by a contact angle meter (Endo Scientific Instrument Co., Ltd.) to become 1 degree or less as a result of penetration.

Less than 30 sec: 5 points
Less than 60 sec: 4 points
Less than 120 sec: 3 points
Less than 360 sec: 2 points
Less than 600 sec: 1 point
600 sec or more: 0 points

Three-dimensional models were produced using binders T-1 to T-26, and subjected to the above-mentioned evaluations. The results are given in Table 1.

TABLE 1

| | | | | | | Discharge | Liquid |
|---|---|---|---|---|---|---|---|
| | | | | | Strength | stability | penetration |
| | | Polymer | | | evaluation | evaluation | evaluation |
| | Binder | Polymer | Mw | Colorant | points | points | points |
| Example 1 | T-1 | Polymer FP-1 | 10,000 | C.I. Acid Red 1 | 5 | 5 | 5 |
| Example 2 | T-2 | Polymer FP-2 | 12,000 | C.I. Acid Red 1 | 4 | 4 | 4 |
| Example 3 | T-3 | Polymer FP-3 | 11,000 | C.I. Acid Red 1 | 4 | 4 | 4 |
| Example 4 | T-4 | Polymer FP-4 | 11,000 | C.I. Acid Red 1 | 4 | 4 | 3 |
| Example 5 | T-5 | Polymer FP-5 | 12,000 | C.I. Acid Red 1 | 4 | 5 | 5 |
| Example 6 | T-6 | Polymer FP-6 | 14,000 | C.I. Acid Red 1 | 4 | 4 | 5 |
| Example 7 | T-7 | Polymer FP-7 | 12,000 | C.I. Acid Red 1 | 5 | 5 | 5 |
| Example 8 | T-8 | Polymer FP-8 | 120,000 | C.I. Acid Red 1 | 4 | 5 | 5 |
| Example 9 | T-9 | Polymer FP-9 | 200,000 | C.I. Acid Red 1 | 4 | 5 | 4 |
| Example 10 | T-10 | Polymer FP-10 | 70,000 | C.I. Acid Red 1 | 5 | 4 | 5 |
| Example 11 | T-11 | Polymer FP-1 | 10,000 | C.I. Basic Red 1 | 5 | 3 | 5 |
| Example 12 | T-12 | Polymer FP-1 | 10,000 | C.I. Acid Blue 1 | 5 | 5 | 5 |
| Example 13 | T-13 | Polymer FP-1 | 10,000 | C.I. Acid Yellow 1 | 5 | 5 | 5 |
| Example 14 | T-14 | Polymer FP-10 | 70,000 | C.I. Acid Yellow 1 | 3 | 4 | 3 |
| Example 15 | T-15 | Polymer FP-11 | 50,000 | C.I. Acid Red 1 | 3 | 4 | 3 |
| Example 16 | T-16 | Polymer FP-12 | 58,000 | C.I. Acid Red 1 | 3 | 3 | 4 |
| Example 17 | T-17 | Polymer FP-13 | 56,000 | C.I. Acid Red 1 | 3 | 3 | 4 |
| Example 18 | T-18 | Polymer FP-14 | 61,000 | C.I. Acid Red 1 | 3 | 3 | 3 |
| Example 19 | T-19 | Polymer FP-15 | 64,000 | C.I. Acid Red 1 | 3 | 3 | 4 |
| Example 20 | T-20 | Polymer FP-16 | 62,000 | C.I. Acid Red 1 | 3 | 3 | 3 |
| Example 21 | T-21 | Polymer FP-17 | 64,000 | C.I. Acid Red 1 | 3 | 4 | 3 |
| Comp. Ex. 1 | T-22 | Polyvinyl alcohol*¹ | 20,000 | C.I. Acid Red 1 | 5 | 2 | 2 |
| Comp. Ex. 2 | T-23 | Polyvinyl-pyrrolidone*² | 40,000 | C.I. Acid Red 1 | 3 | 2 | 3 |
| Comp. Ex. 3 | T-24 | Sodium polystyrene | 70,000 | C.I. Acid Red 1 | 2 | 2 | 4 |
| | | sulfonate*³ | | | | | |
| Comp. Ex. 4 | T-25 | Polyethylene glycol*⁴ | Mn = 1,500 | C.I. Acid Red 1 | 0 | 5 | 5 |
| Comp. Ex. 5 | T-26 | Polyvinylbutyral*⁵ | 90,000 | C.I. Acid Red 1 | 4 | 2 | 3 |

*¹Polyvinyl alcohol 500 (completely saponified type) manufactured by Wako Pure Chemical Industries, Ltd.
*²Polyvinylpyrrolidone K30 manufactured by Wako Pure Chemical Industries, Ltd.
*³Sodium polystyrene sulfonate manufactured by SIGMA ALDRICH
*⁴Polyethylene glycol manufactured by SIGMA ALDRICH
*⁵Polyvinylbutyral manufactured by Wako Pure Chemical Industries, Ltd.

What is claimed is:

1. A process for producing a three-dimensional model, the process comprising sequentially repeating:
a layer formation step of forming on a support a layer of (A) a powder material, the layer having a predetermined thickness; and
a bonding step of bonding the powder material in the layer with (B) a binder so as to give a cross-sectional shape of a modeled object that has been sectioned into parallel cross-sections,
the binder comprising a polymer having a heteroaromatic ring group-containing monomer unit.

2. The process for producing a three-dimensional model according to claim 1, wherein in the bonding step the binder is discharged by inkjet.

3. The process for producing a three-dimensional model according to claim 1, wherein the heteroaromatic ring group-containing monomer unit is represented by Formula (1) below, 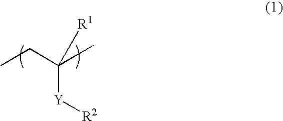
wherein R¹ denotes a hydrogen atom or a hydrocarbon group having 1 to 6 carbon atoms, Y denotes a single bond or a divalent linking group selected from the group consisting of an alkylene group having 1 to 6 carbon atoms, an ester bond, an amide bond, an ether bond, a urethane bond, a urea bond, a thioether bond, and a combination thereof, and R² denotes a 5-membered or 6-membered heteroaromatic ring group having at least one heteroatom selected from the group consisting of a nitrogen atom, an oxygen atom, and a sulfur atom.

4. The process for producing a three-dimensional model according to claim 3, wherein in Formula (1) Y is a single bond.

5. The process for producing a three-dimensional model according to claim 3, wherein in Formula (1) R² denotes a heteroaromatic ring group having a nitrogen atom as a heteroatom.

6. The process for producing a three-dimensional model according to claim 3, wherein in Formula (1) R² is selected from the group consisting of a pyridyl group, a thienyl group, and a furyl group.

7. The process for producing a three-dimensional model according to claim 3, wherein in Formula (1) R² is a pyridyl group.

8. The process for producing a three-dimensional model according to claim 3, wherein of the total monomer units in the polymer having a heteroaromatic ring group-containing monomer unit, at least 85 mole % is a monomer unit represented by Formula (1) above.

9. The process for producing a three-dimensional model according to claim 1, wherein the polymer having a heteroaromatic ring group-containing monomer unit has a weight-average molecular weight of at least 3,000 but no greater than 100,000.

10. The process for producing a three-dimensional model according to claim 1, wherein the powder material is acrylic resin particles, olefin resin particles, phenolic resin particles, styrene resin particles, divinylbenzene resin particles, fluorine resin particles, or urethane resin particles.

11. The process for producing a three-dimensional model according to claim 1, wherein the powder material is acrylic resin particles.

12. The process for producing a three-dimensional model according to claim 1, wherein the binder comprises a colorant.

13. The process for producing a three-dimensional model according to claim 12, wherein the colorant is an anionic dye.

14. The process for producing a three-dimensional model according to claim 1, wherein the binder comprises a solvent.

15. The process for producing a three-dimensional model according to claim 14, wherein the solvent is a water/alcohol mixed solvent.

16. The process for producing a three-dimensional model according to claim 1, wherein the polymer having a heteroaromatic ring group-containing monomer unit in the binder has a content of 1 to 20 wt relative to the total weight of the binder.

17. A three-dimensional model produced by the process for producing a three-dimensional model according to claim 1.
